(19) United States
(12) Patent Application Publication
(10) Pub. No.: US 2024/0289399 A1
(43) Pub. Date: Aug. 29, 2024

(54) SYSTEM, METHOD, AND COMPUTER PROGRAM PRODUCT FOR GENERATING AND PRESENTING CUSTOMIZED MOVIE CONTENT

(71) Applicant: Anup Tikku, Los Gatos, CA (US)

(72) Inventors: Anup Tikku, Los Gatos, CA (US); Arsh Tikku, Los Gatos, CA (US)

(73) Assignee: Anup Tikku, Los Gator, CA (US)

(21) Appl. No.: 18/628,529

(22) Filed: Apr. 5, 2024

Related U.S. Application Data
(63) Continuation of application No. 17/461,354, filed on Aug. 30, 2021.

(51) Int. Cl. G06F 16/9535; G06F 3/01; G06F 16/735; G06F 16/908; G06F 16/9536; G06N 20/00; H04L 65/612

(52) U.S. Cl. CPC G06F 16/9535; G06F 3/011; G06F 16/735; G06F 16/908; G06F 16/9536; G06N 20/00; H04L 65/612

(57) ABSTRACT

Methods, systems, and non-transitory computer programs configured to generate and present customized movie content to a user are disclosed, according to example embodiments. The customized movie content may be generated by an entertainment system from a plurality of content based on at least one or more of user criteria, device criteria, content criteria, and/or environment criteria. The user criteria, device criteria, content criteria and/or environment criteria may be obtained from public and/or private sources of information of a user. To provide an empirically compelling recommendation of the customized movie content, an artificial intelligence agent may be trained to accurately predict an optimized balance between user's interest, content criteria, network performance, device criteria and/or environment criteria. Then, an algorithm may be derived from the trained artificial intelligence agent so that the transmission of the appropriate customized movie content will seek to result in an improved overall relevance of content, avoid repeated requests and disruptions to the user, enhance the resolution, reliability and delivery of the audio and video content, optimize end user device capabilities, reduce communication disruption, interference and latency, and improve the overall entertainment experience for the user. The customized movie content may be presented to the user at an end user device.

### CROSS-REFERENCE TO RELATED PATENT APPLICATION

This application is a continuation of, and claims priority under 35 USC Section 120 of U.S. patent application Ser. No. 17/461,354, filed on Aug. 30, 2021, conf. no. 3365, entitled, “METHOD, SYSTEM & COMPUTER PROGRAM PRODUCT FOR GENERATING AND PRESENTING CUSTOMIZED CONTENT,” the contents of all of which is incorporated herein by reference in its entirety.

### COPYRIGHT OR MASK WORK NOTICE

A portion of the disclosure of this patent document contains material which may be subject to (copyright and/or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### INCORPORATION BY REFERENCE

The following standards/draft standards are hereby [identified as background references]:
1. “High efficiency video coding (HEVC) text specification draft 6. Joint Collaborative Team on Video Coding (JCTVC) of ITU-T SG16 WP3 and ISO/IEC JTC1/SC29/WG 11, 7th Meeting: Geneva, CH, 21-30 Nov. 2011, Document: JCTVC-H1003, 259 pages.
2. International Telecommunication Union, ITU-T, TELECOMMUNICATION STANDARDIZATION SECTOR OF ITU, H.264 (March 2010), SERIES H: AUDIOVISUAL AND MULTIMEDIA SYSTEMS, Infrastructure of audiovisual services—Coding of moving video, Advanced video coding for generic audiovisual services. Recommendation ITU-T H.264, also alternatively referred to as International Telecomm ISO/IEC 14496-10 MPEG-4 Part 10, AVC (Advanced Video Coding), H.264/MPEG-4 Part 10 or AVC (Advanced Video Coding), ITU H.264/MPEG4-AVC, or equivalent.

### BACKGROUND OF THE DISCLOSURE

### 1. Technical Field of the Disclosure

The present disclosure relates in general to an entertainment system and method. More particularly, the disclosure relates to the generation and performance of customized content at a user or an end user device. And even more particularly, the disclosure relates to customized content dynamically generated.

### 2. Related Art

Today, entertainment content may take many different forms. For example, text, graphics, audio and/or video that appears in books, music, movies, videos, computer games, 3D visualizations, holograms, and/or virtual reality and augmented reality experiences, among other things. Similarly, the systems and device form factors for experiencing content can also take a variety of different forms. For example, computing devices may include, e.g., but not limited to, servers, clients, workstations, desktops, notebooks, laptops, digital eBook readers, tablets, phablets, computers, personal computers, handheld devices, phones, mobile phones, smart phones, wearables, smart watches, glasses, neural chips, monitors, televisions and/or projection devices, etc. Such devices may also include wearable interactive devices, such as, e.g., but not limited to, holographic glasses, augmented reality goggles, mixed reality devices, internet contact lenses, and virtual reality headsets, etc. These devices may contain electronic computer processors and electronic computer memory storage devices configured to process and store user preferences, user history, content, aggregated data and artificial intelligence algorithms among other things. The devices may contain electronic sensors, such as, e.g., but not limited to, cameras, microphones, accelerometers, gyroscopes, pressure and temperature sensors, magnetometers, global positioning systems, audio level detection, Light Detection and Ranging (Lidar), and ambient light sensors, etc. The sensors may also include, e.g., but not limited to, barometers, humidity and proximity sensors, touch and fingerprint sensors, and activity and health sensors, etc. Such devices can be connected to a communications network, such as, e.g., but not limited to, voice, data, cable, wired or wireless, public or private, intranet or internet, the Global Internet, cellular, satellite, bus or star topologies, local area, personal area, or wide area, wireless communications networks including, e.g., but not limited to, Wi-Fi, 1G-4G, 5G, nG, Starlink, WiMax, point-to-point, point-to-multipoint, etc., configured to communicate with other exemplary systems and devices, etc.

Typically, a user, or otherwise an end user, who may be, e.g., but not limited to, a reader of a book, listener of music, a viewer of a movie, a player of a computer game or a participant in an augmented reality simulation, experiences using conventional content solutions a static, predetermined entertainment experience usually prepared by the author, creator, director, developer or owner of the content, whether the conventional content solution includes, e.g., but not limited to, a book, music, movie, game and/or AR/VR simulation, etc. Some conventional books or interactive electronic books (e-books) (collectively referred to herein as “books”), for example, may provide a user with options. Examples of these books include, e.g., but not limited to, LEAP FROG's Leap Pad, MAGIC KEY books, and TUMBLE Books, etc. Other examples include The Worst Case Scenario, Ultimate Adventure series by Chronicle Books entitled, MARS (©2011), EVEREST (©2011), and Amazon (©2012). Even with such options, however, these conventional books remain very static and predetermined, according to conventional solutions. For instance, a user reading a conventional mountain climbing adventure book may be presented with the option to have the adventurer climb the mountain summit or the option to have the adventurer shelter and rest in place for the night. The conventional book directs the user to skip to the appropriate part of the book to read the predetermined portion of the story corresponding to the option the user selects. Similarly, almost all conventional movies provide all users with the same entertainment experience. The story, scenes, actors, voices and music score are all identical for each and every user. However, some movies provide the user with options. For instance, some movies provide the user with the option of viewing the Cinematographic release or the Director's Cut release. Even so, each user of either option experiences the same exact movie experience as other users selecting the same option. That is, all users of a Director's Cut release experience the same exact scenes, and the same voices, actors and musical score. Recently, interactive movies have been released. Examples of these interactive movies include, e.g., but not limited to, ‘Chatterbox: Escape the Asylum (©2017)’, ‘Black Mirror Bandersnatch (©2018)’, and ‘You vs. Wild (©2019),’ etc. Such interactive movies, similar to the interactive books discussed above, provide a user with options to select scenes. For instance, a user watching an adventure interactive movie may be presented with the option to view, e.g., having an adventurer ski down a mountain or the adventurer jump off a cliff with a parachute, etc. Conventionally, at a predetermined point in the interactive movie, the movie stops and the user is prompted to select an option from a menu of a plurality of options, after which the interactive movie continues at the appropriate scene corresponding to the option that the user selected. Such interactive movies, similarly to interactive books, remain static and predetermined. All users of conventional interactive movies are provided the same exact options to select from, at the same point in the movie. Moreover, the selected scenes displayed to a viewer user are identical to scenes that all users see who select the same option from the electronic menu of options. This interrupting prompt and user response experience is disruptive and cumbersome. The user conventionally is required to have an input device on hand to quickly select from the options whenever the option is displayed on the screen. If the user fails to successfully lodge the user's selection of the desired option, then the user potentially may proceed in a potentially undesirable direction through the interactive content, as may be the default option of the plurality of options provided for user selection, in the absence of a timely selection. The user's viewing experience is compromised with the frequent disruptions when the movie stops to prompt the user to present the plurality of options, which are often time limited. Many times, conventionally, the user may fumble for the input device, and sometimes the user may press an incorrect key on the input device thereby, possibly, terminating the movie or changing the channel, or worse, potentially interrupting or ending the viewing experience. If the user is watching a movie in the dark, for example, the user may rush to stay ahead of the timer countdown to enter an input, and may by accident select the wrong option. In addition, the user may be pressured to press a key on the input device to select an option within a certain period of time, or lose the opportunity to select an option. Conventionally, it is not uncommon that when a movie stops, an option is presented and the user may scramble to find the remote control and to press the proper key corresponding to the user desired option presented, within the limited time permitted. Inevitably, the user's entertainment experience is jerky, disruptive, pressured and/or panicked. Unfortunately, conventional interactive content solutions are far from an ideal entertainment experience.

What is needed then, is a solution that overcomes shortcomings of conventional solutions.

Conventional computer games and virtual reality simulations are similar, i.e., not too different from one another. Conventional computer games and virtual reality experiences are both interactive, however the options therein are static and predetermined. Examples of conventional interactive computer video games include ‘Minecraft: Story Mode (©2015)’, and ‘Detroit: Become Human (©2018). Examples of virtual reality experiences include Supernatural and Birdly.

Existing conventional entertainment systems are fixed, rigid and limited to the perspective of the content's creator or owner. Conventional interactive books have a fixed set of predetermined text that corresponds to the various options presented to and selectable by a user. Conventional interactive movies, likewise, have fixed predetermined scenes that correspond to the various options presented to and selectable by a user. Similarly, some conventional interactive games provide options for a user to select to pursue a predetermined story line or to unlock predetermined levels in the game. Such conventional interactive experiences remain limited, and are fixed and rigid. Conventional virtual reality experiences provide users the same content options, such as, performing yoga on the same hill on Mars or under the same tree in a redwood forest, or sitting at the same office table in a conference room or riding in the same hot air balloon over Napa Valley. While the hand movements and gestures are unique to a user, the conventional virtual reality experience remains fixed and limited.

There are conventional recommendation services that offer personalized recommendations, such as, allmovie.com, idomoo.com, taste.io. These recommendations, however, have shortcomings, including not being unique to the user but rather are based on aggregated information from others, such as, similar genera of movies watched by third parties, third party user ratings and/or third party reviews etc. Netflix's “Watch Something” for example, merely results in Netflix pushing content it seeks the user to watch based on non-user specific criteria, such as, commercial gain, viewership metrics, and ratings. These conventional recommendation services unfortunately do not provide personalized and customized recommendations based on a specific user's unique interests, preferences, traits and characteristics.

With advancements in such things as computer processing, cloud storage and bandwidth speed, entertainment systems are becoming more and more sophisticated. User expectations are also increasing. Conventional solutions fail to provide, teach or suggest solutions to overcome shortcomings of these solutions. The content viewing user expects a superior, undisrupted, personalized experience with minimal interaction with the entertainment system. Unfortunately conventional solutions fail to provide a solution to overcome shortcomings. Some entertainment systems and methods have tried to keep pace with consumer expectations, but still fall short.

For example, some state of the art conventional entertainment systems provide the user with options to create a more engaging entertainment experience. Yet, these systems merely provide static and fixed predetermined content to the user. Each user experiences the same content in the same sequence as all other users. Conventional systems continue to fail to take into account the preferences and characteristics of a specific user.

Other conventional interactive entertainment systems exist, where the user is prompted to interact with the system to get a more personalized experience, however these too fall short of user expectations and fail to address the shortcomings. For example, for video type content, limited, predetermined video segments corresponding to the options provided to a user, are provided to be viewed by all users. Such interactive entertainment systems merely skip to the video segment that corresponds to the option selected by a user input, such as, through a remote control or other input device. Similarly, for audio or text content, some conventional systems provide options for the user to interact where limited, predetermined audio or text segments corresponding to the options provided to a user are used. Such systems also merely skip to the audio or text segment corresponding to the option selected by the input of the user. For virtual reality content, some conventional existing systems provide options for the user to move within a limited, predetermined simulation that is common to all users of that simulation. Such conventional systems, likewise, merely provide a view that corresponds to the user's spatial perspective based on the goggle or headset position, and fail to address the shortcomings of other solutions, and fail to meet user desires.

Transmission of large amounts of data over long distances presents a challenge for data transmission system, which some state of the art systems have tried to overcome. For example, U.S. Pat. No. 6,982,663 discloses a modified method of compressing data, such as, images, videos, and signals for transmission. The disclosure and teachings of U.S. Pat. No. 6,982,663 are incorporated herein by reference in their entirety. Unfortunately such conventional solutions still fail to overcome shortcomings of conventional solutions.

Further, U.S. Pat. No. 9,332,283 discloses a digital video processing method by signaling of prediction size unit in accordance with video coding. A common or singular binary tree is employed to encode jointly CU prediction and PU partition mode in a single syntax element for both P slices and B slices. The disclosure and teachings of U.S. Pat. No. 9,332,283 are incorporated herein by reference in their entirety.

Load balancing is a significant aspect of delivering content to diverse locations and devices. U.S. Pat. No. 7,266,079, discloses a method of balancing data flow through a communications network by balancing transmission unit traffic over heterogeneous speed network links. The disclosure and teachings of U.S. Pat. No. 7,266,079 are incorporated herein by reference in their entirety.

Content delivery networks are helpful in delivering content to diverse platforms, devices and locations. U.S. Pat. No. 8,392,611B2 discloses a content delivery network. The disclosure and teachings of U.S. Pat. No. 8,392,611B2 are hereby incorporated herein in their entirety.

Further, in content delivery networks quality of service is important. U.S. Pat. No. 8,959,245 discloses a network management server that enables delivery of content via multiple routes to maintain quality of service. The disclosure and teachings of U.S. Pat. No. 8,959,245 are hereby incorporated by reference herein in their entirety.

U.S. Pat. No. 8,270,992 discloses allocation of resources of a second system for a service thereby improving quality of service being provided by a first system to a user. The disclosure and teachings of U.S. Pat. No. 8,270,992 are hereby incorporated by reference herein in their entirety.

U.S. Pat. No. 10,869,220 discloses example techniques to identify and mitigate congestion in a wireless communications network, which is hereby incorporated by reference herein in its entirety.

Certain security considerations may arise using network gateways. The importance of cyber defense capabilities at network gateways is described in the reference, ETSI TR 103 421 V1.1.1 Technical Report Network Gateway Cyber Defence.

U.S. Pat. No. 10,977,647 discloses securely controlling distribution or access for digital content or services using a block chain, which is hereby incorporated by reference herein in its entirety.

Satoshi Nakamoto, “Bitcoin: A Peer-to-Peer Electronic Cash System” is a white paper (May 24, 2009) that describes a peer-to-peer system for electronic transactions using proof of work.

U.S. Pat. No. 4,529,870 discloses a cryptographic apparatus that may be “personalized” to its owner, which is hereby incorporated by reference herein in its entirety.

U.S. Pat. No. 5,956,400 discloses systems for protection of information in which information is fragmented and retrieval of information can be controlled by trusted third parties, which is hereby incorporated by reference herein in its entirety.

U.S. Pat. No. 10,360,495 discloses a decision augmentation system that uses augmented reality and blockchain-technologies, which is hereby incorporated by reference herein in its entirety.

U.S. Pat. No. 8,285,581B2 discloses a system for sequential decision making for customer relationship management that reinforces learning, which is hereby incorporated by reference herein in its entirety.

U.S. Pat. No. 10,726,427B2 discloses a system to create a user profile and provide personalization through compiling interaction data, which is hereby incorporated by reference herein in its entirety.

Streaming and live streaming of content is on rise among users. Over-the-top (OTT) media service is a media service offered directly to viewers via the Internet. OTT bypasses cable, broadcast, and satellite television platforms. It has also been used to describe no-carrier cellphones, where all communications are charged as data, avoiding monopolistic competition, or apps for phones that transmit data in this manner, including both those that replace other call methods and those that update software. OTT can be used for video and audio streaming, messaging services, and VoIP solutions using the internet. The OTT platform is considered to be cheaper and to offer more choice and personalization especially with on demand content. However, OTT media services have failed to provide real time content customization according to a specific user's characteristics and preferences.

Therefore, there is a need for systems and methods for overcoming shortcomings of conventional systems.

### BRIEF SUMMARY OF EXEMPLARY EMBODIMENTS OF THE INVENTION

According to an exemplary embodiment of the present invention, a customized entertainment experience is dynamically presented based on a user's unique characteristics and interests, without the interrupting need to repeatedly stop and start the movie and prompt for user an input. The entertainment experience is not interrupted with queues, questions, prompts for the user, or end user, or the need for the user to otherwise enter an explicit input for the content to resume, according to an exemplary embodiment of the present invention. The entertainment experience in the present invention is not stopped, paused or otherwise delayed, according to an exemplary embodiment of the present invention. Furthermore, the entertainment experience does not involve the distraction of imposing a countdown for the user to provide an explicit input, or face the possibility that the content presented is not based on the user's interests or preferences, according to an exemplary embodiment of the present invention. Rather, according to an exemplary embodiment of the present invention, the content is dynamically generated, and/or presented at the user device, without stops, pauses, interruptions and/or disruptions so the user can enjoy an uninterrupted experience that is customized to his or her interests, preferences and/or liking. According to an exemplary embodiment of the present invention, generation and/or presentation of the customized content may be done in real time, on the fly, immediately, automatically, without noticeable delay by the user, with negligible delay, without user noticeable delay, without interruption during presentation, in the absence of user interruption, or dynamically with immediate sub-second response time. Further, the generation and/or presentation of the customized content may include, but is not limited to, decisions made, or actions triggered, taken or performed, during the execution of a process without any implicit and/or explicit user input or intervention, according to one exemplary embodiment.

According to an exemplary embodiment of the present invention, the customized entertainment experience may include where a user may experience based on a variety of factors, such as, e.g., but not limited to, the user's unique characteristics, preferences, and/or stated or unstated interests, etc. . . . The user may experience places of unique significance to them, such as, e.g., but not limited to, the home where they grew up as a child, and/or the user may experience an interactive conversation with people of importance to them, such as, e.g., but not limited to, grandparents, children and/or with people of importance to humanity, such as, e.g., but not limited to, Mahatma Gandhiji etc.

According to an exemplary embodiment, a method, system, and/or computer program product for dynamically generating and/or performing customized content are disclosed, according to an exemplary embodiment of the present invention. The method, according to an exemplary embodiment of the present invention, may include, e.g., but not limited to, using one or more processors for carrying out the following exemplary steps: (1) determining a base content from a plurality of content derived at least in part from user criteria; (2) determining one or more content subsets based on at least one or more of the user criteria and/or metadata associated with at least one or more of the base content and/or one or more content subsets; (3) selecting a selected one or more of the one or more content subsets based on at least one or more of the user criteria and/or system criteria, etc.; (4) processing the base content and the selected one or more of the one or more content subsets to enable compatibility with one another; (5) generating, a customized content for a user or end user of a device, or otherwise an end user device based on, at least, the system criteria; and/or transmitting the customized content to the user of an end user device, according to an exemplary embodiment of the present invention. The method may further include, e.g., but not limited to, presenting the customized content for display at the end user device, etc., according to an exemplary embodiment of the present invention.

According to an exemplary embodiment, a method of generating and presenting customized content, the method may include, e.g., but not limited to: receiving, by at least one electronic computer processor, a request associated with presenting content from an entertainment system; determining, by at least the at least one electronic computer processor, a base content from a plurality of content, based at least in part on a user criteria; determining, by the at least one electronic computer processor, at least one content subset based on at least one or more of: the user criteria, or a metadata associated with the base content; selecting at least one selected of the at least one content subsets based on at least one or more of: the user criteria, or a device criteria; processing, by the at least one processor, the base content and the at least one selected of the at least one content subsets; generating, by the at least one electronic computer processor, a customized content comprising the base content and the at least one selected of the at least one content subsets for an end user device; and transmitting, by the at least one electronic computer processor, the customized content to the end user device to be presented to a user.

According to an exemplary embodiment, the method may include, e.g., but not limited to, where the determining the base content may include, e.g., but not limited to, storing, by the at least one electronic computer processor, the user criteria in an electronic database, wherein the user criteria include one or more of: user physical factors, cognitive factors, social factors, political factors, economic factors, or consumption factors; storing, by the at least one electronic computer processor, plurality of content in an electronic database, wherein the plurality of content includes at least one or more of: text, images, audio, animations, graphics, three dimensional visuals, or video; accessing, by the at least one electronic computer processor, user selected content from the plurality of content based in part on receiving an input from the user, wherein the input may include, e.g., but not limited to, at least one or more of: a title of a book, a name of a book, a movie, a game, or a music band; accessing, by the at least one electronic computer processor, metadata associated with the user selected content; and analyzing, by the at least one electronic computer processor, the user criteria with the user selected content to determine the base content from the plurality of content.

According to an exemplary embodiment, the method may include, e.g., but not limited to, where the determining the at least one selected of the at least one content subsets may include, e.g., but not limited to, analyzing, by the at least one electronic computer processor, the metadata associated with the base content; analyzing, by the at least one electronic computer processor, the metadata associated with the at least one of the at least one content subsets; analyzing, by the at least one electronic computer processor, the compatibility of the base content with the at least one of the at least one content subsets; identifying, by the at least one electronic computer processor, at least one of the at least one content subsets based on a correlation between the user criteria and the at least one of the least one content subsets; and analyzing, by the at least one electronic computer processor, the user criteria with the at least one of the at least one content subsets to determine the at least one selected of the at least one content subsets.

According to an exemplary embodiment, the method may include, e.g., but not limited to, where the processing the base content and the at least one selected of the at least one content subsets may include, e.g., but not limited to: correlating, by the at least one electronic computer processor, each of the at least one selected of the at least one content subsets with the base content; determining, by the at least one electronic computer processor, a characteristic of each of the at least one selected of the at least one content subsets with the base content and a characteristic of each of the at least one content subsets with others of the at least one selected of the at least one content subsets based on at least one or more of: a data signature, fingerprint code, a timestamp, or metadata of the base content, or the at least one selected of the at least one content subsets; and transcoding, by the at least one electronic computer processor, the at least one selected of the at least one content subsets for compatibility with the base content.

According to an exemplary embodiment, the method may include, e.g., but not limited to, where the generating a customized content may include, e.g., but not limited to, receiving, by the at least one electronic computer processor, the device criteria of the end user device, wherein the device criteria may include, e.g., but not limited to, at least one of: type of device, software and hardware capabilities, audio and video capabilities, processing capabilities, or communication capabilities; processing, by the at least one electronic computer processor, the base content and the at least one selected of the at least one content subsets based on the device criteria; determining, by the at least one electronic computer processor, interleaving characteristics of the base content and the at least one selected of the at least one content subsets based on at least one or more of: the user criteria, the device criteria, the ambient criteria, or the content criteria; wrapping, by the at least one electronic computer processor, the base content and the one or more selected content subsets for transmission to the end user device; merging, by the at least one electronic computer processor, the base content and the one or more selected content subsets into a group of temporally overlapping content; and synthesizing, by the at least one electronic computer processor, the group of temporally overlapping content into a customized content.

According to an exemplary embodiment, the method may include, e.g., but not limited to, where the determining the base content may include, e.g., but not limited to, determining, by the at least one electronic computer processor, the user criteria based on the stored user information, user information obtained in real-time using artificial intelligence or machine learning techniques, user information determined from merging and weighting of user criteria associated with two or more users.

According to an exemplary embodiment, the method may include where the physical factors associated with a user include at least one or more of: age, gender, height, eye sight abilities, hearing abilities, or physical health of the user.

According to an exemplary embodiment, the method may include, e.g., but not limited to, where the consumption factors associated with the user may include, e.g., but not limited to, at least one or more of a public or private information associated with the activity of the user including content, social media, viewing activities, reviews, posts, share, or recommendations, wherein the consumption factors are determined automatically by a system using at least one of: artificial intelligence (AI), or machine leaning (ML) methods.

According to an exemplary embodiment, the method may include, e.g., but not limited to, where the ambience criteria may include, e.g., but not limited to, at least one or more of: a type of the end user device, processing, audio, video, resolution capabilities, communications connectivity or network connectivity of the end user device, the light or acoustic characteristics at the location of the end user device, or the temperature or humidity at the location of the end user device.

According to an exemplary embodiment, the method may include, e.g., but not limited to, where the storing the user criteria in the electronic database may include, e.g., but not limited to, storing, by the at least one electronic computer processor, at least one or more of: user entered information, publicly available information associated with the user, or information entered using a human machine interface method.

According to an exemplary embodiment, the method may include, e.g., but not limited to, where the human machine interface method may include, e.g., but not limited to, providing, by the at least one electronic computer processor, an input to the end user device based on at least one or more of: a gesture from a user, facial expression of the user, brain activity of the user, eye movement of the user, or an audio generated by the user.

According to an exemplary embodiment, the method may include, e.g., but not limited to, where the presenting the customized content for display, may include, e.g., but not limited to, wherein the presentation of the customized content occurs on the end user device following the transmitting, wherein transmission is from distributed electronic content storage systems.

According to an exemplary embodiment, the method may include where the end user device may include, e.g., but not limited to, at least one or more of: a tablet, a smart speaker, a smart phone, a virtual reality display, a display monitor, or at least one network connected lens.

According to an exemplary embodiment, the method may include, e.g., but not limited to, where the storing of the plurality of content may include, e.g., but not limited to, tagging of the plurality of content with predetermined or real-time information, the information including information about at least one or more of: a start scene, a stop scene, an actor, an author, an artist, a singer, a director, a content resolution, a length, a language, or a time stamp.

According to an exemplary embodiment, the method may include, e.g., but not limited to, where the processing may include, e.g., but not limited to, determining, by the at least one electronic computer processor, a compatible insertion location at the beginning, within, or at an end of the base content for each of the one or more selected content subsets to be inserted into the base content to generate the customized content.

According to an exemplary embodiment, the method may include, e.g., but not limited to, where the presenting may include, e.g., but not limited to, adapting, by the at least one electronic computer processor, the insertion of the at least one selected of the at least one content subsets into the base content based on a real-time bandwidth connection characteristics with the end user device.

According to an exemplary embodiment, the method may include where the insertion location is determined, by the at least one electronic computer processor, using an artificial intelligence or a machine learning method.

According to an exemplary embodiment, the method may include, e.g., but not limited to, where the machine learning method may include, e.g., but not limited to, at least one or more of: a supervised learning method, an unsupervised learning method, or a reinforcement learning method.

According to an exemplary embodiment, the method may include, e.g., but not limited to, where the machine learning method may include, e.g., but not limited to, at least one or more of: linear regression, logistic regression, decision tree, support vector machine (SVM), naive bayes, k-nearest neighbors (kNN), k-means clustering, random forest, dimensionality reduction, or gradient boosting algorithm.

According to an exemplary embodiment, the method may include, e.g., but not limited to, where the processing may include, e.g., but not limited to, inserting, by the at least one electronic computer processor, at least one selected of the at least one content subsets into the base content based on a score for each of the at least one content subset, wherein the score is determined based on weighted summation of user criteria score of two or more users.

According to an exemplary embodiment, the method may include where the base content may include, e.g., but not limited to, a live video stream and the at least one selected of the at least one content subsets may include, e.g., but not limited to, at least one or more of: text, image, audio, video, animation, or graphics.

According to another exemplary embodiment, a computing system may be configured to generate and present customized content, the computing system may include, e.g., but not limited to, at least one non-transitory memory device configured to store instructions; at least one memory having stored thereon a user criteria and a plurality of content, wherein the plurality of content may include, e.g., but not limited to, at least one or more of: text, images, audio, animations, games, augmented reality simulation, virtual reality simulation, graphics, holograms, three dimensional visuals, or video; and at least one hardware processor communicatively coupled to the at least one non-transitory memory device and configured to execute the instructions to cause the computing system to perform operations may include, e.g., but not limited to: determine a base content from a plurality of content, based at least in part on a user criteria; determine at least one content subset based on at least one or more of: the user criteria, or a metadata associated with the base content; select at least one selected of the at least one content subsets based on at least one or more of: the user criteria, or a device criteria; process the base content and the at least one selected of the at least one content subsets; generate a customized content comprising the base content and the at least one selected of the at least one content subsets for an end user device; and transmitting the customized content to the end user device to be presented to a user.

According to an exemplary embodiment, the system may include, e.g., but not limited to, where the memory may include, e.g., but not limited to, a distributed and network connected database.

According to an exemplary embodiment, the system may include, e.g., but not limited to, where the at least a portion of the system resides on the end user device.

According to an exemplary embodiment, the system may include, e.g., but not limited to, where the system resides on a cloud system and is communicatively coupled to the end user device through at least one content delivery network.

According to an exemplary embodiment, the system may include, e.g., but not limited to, where the generating a customized content occurs without receipt of any explicit input from the user during presentation.

According to an exemplary embodiment, the system may include, e.g., but not limited to, where the system may include, e.g., but not limited to, an artificial intelligence software agent instructions, wherein the artificial intelligence software agent instructions is configured to determine the customized content based on the base content, one or more content subsets, and a content subset criteria, wherein the content subset criteria is determined based on at least one or more of: the user criteria, the device criteria, the ambience criteria, or the content criteria.

According to an exemplary embodiment, the system may include where the user criteria include at least one or more of: user physical factors, cognitive factors, social factors, political factors, economic factors, consumption factors, cultural factors, geographic factors, educational factors, activity factors, or other factors.

According to an exemplary embodiment, the system may include, e.g., but not limited to, where the device criteria include at least one or more of: type of device, software capabilities, hardware capabilities, audio capabilities, video capabilities, processing capabilities, or communication capabilities.

According to an exemplary embodiment, the system may include, e.g., but not limited to, where the end user device is at least one or more of: a tablet, a phablet, a smart speaker, a smart phone, a virtual reality headset, an augmented reality headset, a mixed reality headset, a monitor, a display, a smart television, a projector, or a network connected lens.

According to an exemplary embodiment, the system may include, e.g., but not limited to, where the system further may include, e.g., but not limited to, at least one or more of: a content encoder, a content decoder, a multiplexer, a de-multiplexer, or a transcoder.

According to an exemplary embodiment, the system may include, e.g., but not limited to, where the plurality of content is stored on a cloud system and the customized content is generated on the cloud system and transmitted to the end user device in at least one or more of: real time; on the fly; immediately; dynamically; automatically; without noticeable delay by the user; with negligible delay; without user noticeable delay; without interruption during presentation; in the absence of user interruption; or dynamically with immediate sub-second response time.

According to yet another exemplary embodiment, a non-transitory computer program product embodied on a nontransitory computer accessible medium may include, e.g., but not limited to, at least one program code instruction, the at least one program code instruction configured to enable when executed on at least one electronic computer processor to generate and present customized content to a user, the nontransitory computer program product comprising the at least one program code instruction to: determine a base content from a plurality of content, based at least in part on a user criteria; determine at least one content subsets based on at least one or more of: the user criteria, or a metadata associated with the base content; select at least one selected of the at least one content subsets based on at least one or more of: the user criteria, or a device criteria; process the base content and the at least one selected of the at least one content subsets; and generate a customized content comprising the base content and the selected of the at least one content subsets for an end user device; transmit the customized content to the end user device to be presented to a user.

According to an exemplary embodiment, the computer program product may include, e.g., but not limited to, where the at least one program code instruction to determine the base content may include, e.g., but not limited to, the at least one program code instruction to: store the user criteria in an electronic database, wherein the user criteria include at least one or more of: user physical factors, cognitive factors, social factors, political factors, economic factors, or consumption factors; store plurality of content in an electronic database, wherein the plurality of content includes at least one or more of: text, images, audio, animations, graphics, three dimensional visuals, or video; access user selected content from the plurality of content based in part on receiving an input from the user, wherein the input includes at least one or more of: a title of a book, a name of a book, movie, game, band, or a virtual reality simulation; access metadata associated with the user selected content; and analyze the user criteria with the user selected content to determine the base content from the plurality of content.

According to an exemplary embodiment, the computer program product may include where the at least one program code instruction to determine the selected of at least one selected of the at least one content subsets may include, e.g., but not limited to, wherein the at least one program code instruction to: analyze the metadata associated with the base content; analyze the metadata associated with the one or more content subsets; analyze the compatibility of the base content with the at least one content subsets; identify the at least one content subsets based on a correlation between the user criteria and the at least one content subsets; and analyze the user criteria with the at least one content subsets to determine the one or more selected content subsets.

According to an exemplary embodiment, the method, system or computer program product may include, e.g., but not limited to, where the generating may include, e.g., but not limited to, at least one or more of: generating the customized content without requesting input from a user; generating the customized content absent requesting interactive input during the presenting of the content; generating the customized content dynamically without requesting input from a user; generating the customized content automatically without requesting input from a user; generating the customized content dynamically without requesting input from a user during the presenting of the content; generating the customized content automatically without requesting input from a user during the presenting of the content; generating the customized content dynamically without requesting input from a user avoiding interruption; generating the customized content automatically without requesting input from a user avoiding interruption; generating the customized content avoiding interruption during the presenting of the content; generating the customized content eliminating interruption during the presenting of the content; or generating the customized content to obtain an absence of interruption during the presenting of the content.

According to an exemplary embodiment, the method, the system, or the computer program product may further include, e.g., but not limited to, presenting, at the end user device, by at least one electronic computer processor, which may include, e.g., but not limited to, at least one or more of: presenting the customized content at the end user device; presenting the customized content without requesting input from a user; presenting the customized content absent requesting interactive input during the presenting of the content; presenting the customized content dynamically without requesting input from a user; presenting the customized content automatically without requesting input from a user; presenting the customized content dynamically without requesting input from a user during the presenting of the content; presenting the customized content automatically without requesting input from a user during the presenting of the content; presenting the customized content dynamically without requesting input from a user avoiding interruption; presenting the customized content automatically without requesting input from a user avoiding interruption; presenting the customized content avoiding interruption during the presenting of the content; presenting the customized content eliminating interruption during the presenting of the content; or presenting the customized content to obtain an absence of interruption during the presenting of the content.

According to an exemplary embodiment, the method, the system or the computer program product may include, e.g., but not limited to, where the presenting, at the end user device, by the at least one electronic computer processor, may include, e.g., but not limited to, at least one or more of: presenting the customized content in video display form; presenting the customized content in audio form; presenting the customized content in virtual reality form; presenting the customized content in augmented reality form; presenting the customized content in mixed reality form; presenting the customized content in a smart television form; presenting the customized content in a theatrical performance form; or presenting the customized content on a mobile device.

According to another exemplary embodiment, a method, a system, or a the computer program product may include, e.g., but not limited to, a method of generating and presenting customized movie content, the method may include: receiving, by at least one electronic computer processor, an electronic request associated with movie content to be presented from an entertainment system; electronically storing, by the at least one electronic computer processor, a plurality of movie content; electronically tagging, by the at least one electronic computer processor, at least a portion of the plurality of movie content with at least one or more of: stored information, or real-time information; first electronically determining, by the at least one electronic computer processor, a base movie content from the plurality of movie content, based at least in part on at least one user criteria of at least one or more of: at least one end user, at least one end user device, or at least one entertainment system, wherein the at least one user criteria is based on at least one user information; electronically accessing, by the at least one electronic computer processor, at least one metadata associated with the base movie content; electronically analyzing at least one capability of at least one or more of: the at least one end user device, the at least one end user, the at least one entertainment system, or at least one end user environment; second electronically determining, by the at least one electronic computer processor, at least one movie content subset based on at least one or more of: the at least one user criteria, or the least one metadata associated with the base movie content; electronically selecting, by the at least one electronic computer processor, without requesting an acceptance confirmation from the end user, at least one selected of the at least one movie content subset, based on at least one or more of: the at least one user criteria, the at least one or more entertainment system criteria, the at least one metadata associated with the base movie content, the at least one capability of the at least one end user device, the at least one interest of the at least one end user, the at least one capability of the at least one entertainment system, or the at least one capability of the at least one end user environment; wherein the electronically selecting the least one stored user information is obtained and analyzed, at least in part, using at least one artificial intelligence technique or at least one machine learning technique; electronically processing, by the at least one electronic computer processor, of the base movie content and the at least one selected of the at least one movie content subset, wherein the electronic processing of the base movie content and the at least one selected of the at least one movie content subset may include: third electronically determining, by the at least one electronic computer processor, at least one insertion location associated with the base movie content for the at least one selected of the at least one movie content subset to be at least one or more of inserted, combined, merged or linked with the base movie content; wherein the electronically processing of the base movie content and the at least one selected of the at least one movie content subset is derived, at least in part, using at least one artificial intelligence technique, electronically generating, by the at least one electronic computer processor, a customized movie content comprising the base movie content and the at least one selected of the at least one movie content subset for the at least one end user device; electronically evaluating one or more conditions related to network communications, bandwidth, or network security; and electronically transmitting, by the at least one electronic computer processor, the customized movie content to the at least one end user device.

According to one embodiment, the method may include where the first electronically determining the base movie content may include: electronically storing, by the at least one electronic computer processor, the at least one user criteria in an electronic database, wherein the at least one user criteria may include at least one or more of: at least one physical factor of the user, at least one cognitive factor, at least one social factor, at least one political factor, at least one cultural factor, at least one economic factor, or at least one consumption factor; electronically storing, by the at least one electronic computer processor, at least one or more of: user entered information, publicly available information associated with the at least one end user, or information entered using a human machine interface method; electronically storing, by the at least one electronic computer processor, a plurality of movie content in an electronic database, wherein the plurality of movie content may include at least one or more of: at least one audio, at least one animation, at least one graphic, at least one three dimensional visual, at least one video, or at least one language translation subtitle; electronically accessing, by the at least one electronic computer processor, user selected movie content from the plurality of movie content based at least in part on receiving an input from the at least one end user, wherein the input may include at least one or more of: a name of a book, a name of a movie, a name of a person, a name of an actor, a name of a character, a name of historical event, or a cultural factor; electronically accessing, by the at least one electronic computer processor, at least one metadata associated with the user selected movie content; and electronically analyzing, by the at least one electronic computer processor, the at least one user criteria with the user selected movie content to fourth electronically determine the base content from the plurality of content.

According to one embodiment, the method may include where the second electronically determining the at least one selected of the at least one movie content subset may include: analyzing, by the at least one electronic computer processor, the at least one metadata associated with the base movie content; analyzing, by the at least one electronic computer processor, at least one metadata associated with the at least one of the at least one movie content subset; analyzing, by the at least one electronic computer processor, the compatibility of the base movie content with the at least one of the at least one movie content subset; identifying, by the at least one electronic computer processor, at least one of the at least one movie content subset based on a correlation between the user criteria and the at least one of the least one movie content subset; and analyzing, by the at least one electronic computer processor, the at least one user criteria with the at least one of the at least one movie content subset to determine the at least one selected of the at least one movie content subset.

According to one embodiment, the method may include where electronic processing of the base movie content and the at least one selected of the at least one movie content subset may include: electronically correlating, by the at least one electronic computer processor, each of the at least one selected of the at least one movie content subset with the base movie content; fourth electronically determining, by the at least one electronic computer processor, a characteristic of each of the at least one selected of the at least one movie content subset with a characteristic of the base movie content and a characteristic of each of the at least one movie content subset with a characteristic of the others of the at least one selected of the at least one movie content subset based on at least one or more of: a data signature, fingerprint code, a timestamp, or the metadata of the base movie content; and electronically transcoding, by the at least one electronic computer processor, the at least one selected of the at least one movie content subset for compatibility with the base movie content.

According to one embodiment, the method may include where identifying at least one of the at least one movie content subset based on a correlation between the user criteria and the at least one of the least one movie content subset may include: determining one or more movie content metadata parameters of a particular movie content subset; determining one or more user criteria parameters of at least one end user; evaluating one or more pre-identification movie content metadata parameters and one or more user criteria parameters before the particular movie content subset is identified; providing, as input to an algorithm derived at least in part from an artificial intelligence agent, the one or more pre-identification user criteria parameters and the one or more pre-identification movie content metadata parameters; determining, as output from the algorithm, at least one particular movie content subset; and then identifying the at least one particular movie content subset correlating to the user criteria.

According to one embodiment, the method may include where electronically generating the customized movie content may include: electronically receiving, by the at least one electronic computer processor, the at least one capability of the at least one end user device comprising device criteria, wherein the device criteria include at least one of: type of device, software capabilities, hardware capabilities, audio capabilities, video capabilities, processing capabilities, or communication capabilities; electronically processing, by the at least one electronic computer processor, the base movie content and the at least one selected of the at least one movie content subset based on the device criteria; fifth electronically determining, by the at least one electronic computer processor, interleaving characteristics of the base movie content and the at least one selected of the at least one movie content subset based on at least one or more of: the user criteria, the device criteria, the ambient criteria, the environment criteria, or the content criteria; electronically wrapping, by the at least one electronic computer processor, the base movie content and the one or more selected movie content subsets; electronically merging, by the at least one electronic computer processor, the base movie content and the one or more selected movie content subsets into a group of temporally overlapping movie content; and electronically synthesizing, by the at least one electronic computer processor, the group of temporally overlapping movie content into the customized movie content for transmission to the at least one end user device.

According to one embodiment, the method may include where the electronically determining interleaving characteristics of the base movie content and the at least one selected movie content subsets, may include: determining one or more pre-interleaved base movie content metadata parameter; determining one or more pre-interleaved movie content subset metadata parameter; determining one or more user criteria, device criteria, environment criteria, or content criteria parameter; evaluating one or more pre-interleaved base movie content metadata parameter, one or more pre-interleaved movie content subset metadata parameter and one or more user criteria, device criteria, environment criteria, or content criteria parameter before the particular base content and at least one movie content subset are interleaved; providing, as input to an algorithm derived at least in part from an artificial intelligence agent, the one or more pre-interleaved base movie content metadata parameter, the pre-interleaved movie content subset metadata parameter and the one or more user criteria, device criteria, environment criteria, or content criteria parameter; determining, as output from the algorithm, at least one particular base movie content metadata parameter and at least one particular movie content subset metadata parameter; and identifying the at least one particular base movie content and at least one particular movie content subset taking into consideration one or more user criteria, device criteria, environment criteria, or content criteria parameter.

According to one embodiment, the method may include where the first electronically determining the base movie content may include fourth electronically determining, by the at least one electronic computer processor, the user criteria based on the at least one stored user information, wherein the at least one stored user information is analyzed and obtained in real-time using at least one artificial intelligence technique, and wherein the at least one stored user information is determined from merging and weighting of user criteria associated with two or more end users.

According to one embodiment, the method may include where the human machine interface method may include providing, by the at least one electronic computer processor, an input to the at least one end user device based on at least one or more of: a gesture from the at least one end user, a facial expression of the at least one end user, a brain activity of the at least one end user, an eye movement of the at least one end user, an audio sound generated by the at least one end user, or a biometric information of the at least one end user.

According to one embodiment, the method may include where the electronically storing of the plurality of movie content and the electronically tagging of the plurality of movie content with stored, predetermined, or real-time information, wherein the information further may include: information about at least one or more of: a timestamp, a start scene, a stop scene, a beginning scene, an end scene, a person, an actor, an author, an artist, a singer, a director, a family member, a friend, a content resolution, a length, a language, or a cultural factor.

According to one embodiment, the method may include where the electronically processing may include wherein the third electronically determining, by the at least one electronic computer processor, the at least one insertion location of the base movie content, wherein the at least one insertion location may include at least one compatible insertion location: wherein the at least one compatible insertion location may include at least one or more of: at the beginning of, within, or at the end of, the base movie content, for each of the one or more selected movie content subset to be inserted into the base movie content to generate the customized movie content.

According to one embodiment, the method may include where the determining of a compatible insertion location may include: determining one or more pre-insertion base movie content metadata; determining one or more pre-insertion movie content subset metadata; determining one or more user criteria, device criteria, ambient criteria, environment criteria, or content criteria; evaluating one or more pre-insertion base movie content metadata, one or more pre-insertion movie content subset metadata and one or more user criteria, device criteria, ambient criteria, environment criteria, or content criteria before the at least one compatible insertion location is identified; providing, as input to an algorithm derived at least in part from a machine learning technique, the one or more pre-insertion base movie content metadata, the pre-insertion movie content subset metadata and the one or more user criteria, device criteria, ambient criteria, environment criteria, or content criteria; determining, as output from the algorithm, at least one particular base movie content metadata and at least one particular movie content subset metadata; and identifying the at least one compatible insertion location for the at least one particular base movie content or the at least one particular movie content subset taking into consideration one or more of: content criteria, user criteria, ambient criteria, environment criteria, or device criteria.

According to one embodiment, the method may include where the machine learning technique may include at least one or more of: linear regression, logistic regression, decision tree, support vector machine (SVM), naïve bayes, k-nearest neighbors (kNN), k-means clustering, random forest, dimensionality reduction, or gradient boosting algorithm.

According to one embodiment, the method may include where the electronically processing may include electronically inserting, by the at least one electronic computer processor, at least one selected of the at least one movie content subset into the base movie content based on a score for each of the at least one movie content subset, wherein the score is fourth electronically determined, by the at least one electronic computer processor, based on at least one weighted summation of a plurality of the at least one user criteria of at least two or more of the at least one end user.

According to one embodiment, the method may include where the electronically processing the base movie content and the at least one selected of the at least one movie content subset may include: evaluating, as input to an algorithm derived at least in part from an artificial intelligence agent, at least one or more of: audio, video or text information; determining, as output from the algorithm, a language translation for at least one or more of: audio, video or text information; and identifying a compatible format for the language translation correlating to the base movie content and the at least one selected movie content subset.

According to another embodiment, a computing system configured to generate and transmit customized movie content, the computing system may include: at least one memory device configured to electronically store instructions, wherein the at least one memory device having electronically stored thereon at least one user criteria and a plurality of movie content, wherein the plurality of movie content may include at least one or more of: at least one text content, at least one image content, at least one audio content, at least one video content, at least one animation content, at least one game content, at least one augmented reality simulation content, at least one virtual reality simulation content, at least one graphic content, at least one hologram content, at least one language translation content, at least one three dimensional visual content, or at least one electronic computer processor communicatively coupled to the at least one memory device and configured to execute the instructions to cause the computing system to perform operations comprising to: electronically tag at least a portion of the plurality of movie content with at least one or more of: stored information, or real-time information; first electronically determine a base movie content from the plurality of movie content, based at least in part on the at least one user criteria, wherein the at least one user criteria is based on at least one user information; electronically access at least one metadata associated with the base movie content; electronically analyze at least one capability of at least one or more of: at least one end user device, the at least one end user, or at least one end user environment; second electronically determine at least one movie content subset based on at least one or more of: at least one user criteria, at least one capability of the at least one end user device, at least one interest of the at least one end user, at least one cultural factor, at least one capability of the at least one end user environment, or the at least one metadata associated with the base movie content; electronically select at least one selected of the at least one movie content subset, without requesting an acceptance confirmation from the end user, based on at least one or more of: the at least one user criteria, the at least one metadata associated with the base movie content, the at least one capability of the at least one end user device, the at least one cultural factor, the at least one interest of the at least one end user, or the at least one capability of the at least one end user environment; and wherein the electronically select at least one selected of the at least one movie content subset is obtained and analyzed, at least in part, using at least one artificial intelligence technique or machine learning technique; electronically process the base movie content and the at least one selected of the at least one movie content subset may include: third electronically determine at least one insertion location associated with the base movie content for the at least one selected of the at least one movie content subset to be inserted into the base movie content; and wherein the electronically process of the base movie content and the at least one selected of the at least one movie content subset is derived, at least in part, using at least one artificial intelligence technique or machine learning technique; electronically generate a customized movie content comprising the base movie content and the at least one selected of the at least one movie content subset for at least one end user device; electronically evaluate one or more conditions relating to a network communication, a network bandwidth, or a network security; and electronically transmit the customized movie content to the at least one end user device.

According to one embodiment, the system may include where the electronically process the base movie content and the at least one selected of the at least one movie content subset may include: evaluate, as input to an algorithm derived at least in part from an artificial intelligence agent, at least one or more of: audio, video, or text information; determine, as output from the algorithm, a language translation for at least one or more of: the audio, video or text information; and identify a compatible format for the language translation correlating to the base movie content and the at least one selected movie content subset.

According to one embodiment, the system may include where the language translation for the audio, video or text information includes two or more cultural factors.

According to one embodiment, the system may include at least one artificial intelligence software agent instruction, wherein the at least one artificial intelligence software agent instruction is configured: determine one or more pre-insertion base movie content metadata parameters; determine one or more pre-insertion movie content subset metadata parameters;
determine one or more user criteria, device criteria, ambient criteria, cultural factors, or content criteria parameters; evaluate one or more pre-insertion base movie content metadata parameters, one or more pre-insertion movie content subset metadata parameters and one or more user criteria, device criteria, ambient criteria, cultural factors, or content criteria parameters before the at least one compatible insertion location is identified; provide, as input to an algorithm derived at least in part from an artificial intelligence agent, the one or more pre-insertion base movie content metadata parameters, the pre-insertion movie content subset metadata parameters and the one or more user criteria, device criteria, ambient criteria, cultural factor, or content criteria parameters; determine, as output from the algorithm, at least one particular base movie content metadata parameter and at least one particular movie content subset metadata parameter; and identify the at least one compatible insertion location for the at least one particular base movie content or the at least one particular movie content subset by analyzing one or more of: content criteria, user criteria, cultural factors, or user device criteria parameters.

According to yet another embodiment, a non-transitory computer program product embodied on a nontransitory computer accessible storage medium may include at least one program code instruction, the at least one program code instruction configured to enable when executed on at least one electronic computer processor to generate and transmit customized movie content to at least one end user, the nontransitory computer program product may include the at least one program code instruction configured to enable the at least one electronic computer processor to: electronically tag at least a portion of a plurality of movie content with at least one or more of: stored information, or real-time information; first electronically determine a base movie content from the plurality of movie content, based at least in part on at least one user criteria, and wherein the at least one user criteria is based on at least one user information; electronically access at least one metadata associated with the base movie content; electronically analyze at least one capability of at least one or more of: at least one end user device, the at least one end user, or at least one end user environment; second electronically determine at least one movie content subset based on at least one or more of: the at least one user criteria, the at least one capability of the at least one end user device, the at least one interest of the at least one end user, the at least one capability of the at least one end user environment, or the at least one metadata associated with the base movie content; electronically select at least one selected of the at least one movie content subset, without a request for an end user acceptance confirmation, based on at least one or more of: the at least one user criteria, the at least one metadata associated with the base movie content, the at least one capability of the at least one end user device, the at least one interest of the at least one end user, or the at least one capability of the at least one end user environment, and wherein the electronically select at least one selected of the at least one movie content subset is obtained and analyzed, at least in part, using at least one artificial intelligence technique or machine learning technique; electronically process the base movie content and the at least one selected of the at least one movie content subset comprising: third electronically determine at least one insertion location associated with the base movie content for the at least one selected of the at least one movie content subset to be inserted, combined, merged or linked with the base movie content, and wherein the electronically process of the base movie content and the at least one selected of the at least one movie content subset is derived, at least in part, using at least one artificial intelligence method or machine learning method; electronically generate a customized movie content comprising the base movie content and the at least one selected of the at least one movie content subset for at least one end user device; electronically evaluate at least one condition relating to at least one or more of: a network communication parameter, a network bandwidth parameter, or a network security parameter; and electronically transmit the customized movie content to the at least one end user device.

According to one embodiment, the computer program product may include where the at least one program code instruction to first electronically determine the base movie content may include the at least one program code instruction configured to: electronically store the user criteria in an electronic database, wherein the at least one user criteria comprise at least one or more of: at least one user physical factor, at least one cognitive factor, at least one social factor, at least one cultural factor, at least one political factor, at least one economic factor, or at least one consumption factor; electronically store plurality of movie content in an electronic database, wherein the plurality of movie content may include at least one or more of: at least one text, at least one image, at least one audio, at least one language translation, at least one animation, at least one graphic, at least one three dimensional visual, or at least one video; electronically access user selected movie content from the plurality of movie content based in part on receiving an input from the user, wherein the input may include at least one or more of: a name of a book, a name of movie, a name of game, a name of a person, a name of music band, or a name of a virtual or augmented reality simulation; electronically access at least one metadata associated with the user selected movie content; and electronically analyze the at least one user criteria with the user selected movie content to fourth electronically determine the base movie content from the plurality of movie content.

According to one embodiment, the computer program product may include where the at least one program code instruction to determine the selected of at least one selected of the at least one movie content subset may include wherein the at least one program code instruction to: analyze the at least one metadata associated with the base movie content; analyze at least one metadata associated with the one or more movie content subsets; analyze the compatibility of the base movie content with the at least one movie content subset; identify the at least one movie content subset based on a correlation between the at least one user criteria and the at least one movie content subset; and analyze the user criteria with the at least one movie content subset to determine the one or more selected content subsets.

According to one embodiment, the computer program product may include where the at least one program code instruction to determine an insertion location may include wherein the at least one program code instruction to: determine one or more pre-insertion base movie content metadata; determine one or more pre-insertion movie content subset metadata; determine one or more user criteria, device criteria, ambient criteria, or content criteria; evaluate one or more pre-insertion base movie content metadata, one or more pre-insertion movie content subset metadata and one or more user criteria, device criteria, ambient criteria, or content criteria before the at least one insertion location is identified; provide, as input to an algorithm derived at least in part from a machine learning method, the one or more pre-insertion base movie content metadata, the pre-insertion movie content subset metadata, or the one or more user criteria, device criteria, ambient criteria, or content criteria; determine, as output from the algorithm, at least one particular base movie content metadata and at least one particular movie content subset metadata; and identify the at least one insertion location for the at least one particular base movie content or the at least one particular movie content subset taking into consideration one or more content criteria, user criteria, or device criteria.

According to one embodiment, the computer program product may include where the at least one program code instruction to derive an algorithm at least in part from a machine learning method may include wherein the at least one program code instruction to: utilize at least one or more of linear regression, logistic regression, decision tree, random forest, dimensionality reduction, or gradient boosting.

Other systems, methods, features and advantages of the invention may be or will become apparent to one skilled in the art upon examination of the following drawings and detailed description. It is intended that all such additional exemplary systems, methods, computer program products, features, objects, and advantages be included within this detailed description, be within the scope of the invention, and be protected by should only be limited by the required features included in the accompanying claims.

### BRIEF DESCRIPTION OF THE DRAWING FIGURES

The included drawings are for illustrative purposes and serve only to provide examples of possible exemplary systems, computer program products on nontransitory accessible media, and/or methods, etc., for the disclosed customized exemplary content systems of various exemplary embodiments, according to an exemplary embodiment of the present invention. The drawings in no way limit any changes in any form and detail that may be made to that which is disclosed by one skilled in the art without departing from the spirit and scope of this disclosure.

FIG. 1 illustrates an example high level block diagram of a network environment 100 including an example entertainment system 102, according to an embodiment of the present invention;

FIG. 2 illustrates an example high level flow diagram 200 including the example entertainment system 102, according to an embodiment of the present invention;

FIG. 3 illustrates an example high level block diagram of the example entertainment system 102, according to an embodiment of the present invention;

FIG. 4 illustrates through an example block diagram an example base content module 306, according to an embodiment of the present invention;

FIG. 5 illustrates through an example block diagram example content 214, according to an embodiment of the present invention;

FIG. 6 illustrates through an example block diagram metadata 602, according to an embodiment of the present invention;

FIG. 7 illustrates through an example block diagram elements of example metadata 602, according to an embodiment of the present invention;

FIG. 8 illustrates through an example block diagram elements of example content 214, according to an embodiment of the present invention;

FIG. 9 illustrates an example multidimensional vector space 900 and an example TABLE 902, according to an embodiment of the present invention;

FIG. 10 illustrates through an example block diagram elements of example user criteria (UC) 204, according to an embodiment of the present invention;

FIG. 11 illustrates an example table 1100, according to an embodiment of the present invention;

FIG. 12 illustrates an example table 1200, according to an embodiment of the present invention;

FIG. 13 illustrates an example table 1300, according to an embodiment of the present invention;

FIG. 14 illustrates an example table 1400, according to an embodiment of the present invention;

FIG. 15 illustrates an example flow diagram 1500 for generation of an example content subset criteria 202, according to an embodiment of the present invention;

FIG. 16 illustrates an example flow diagram 1600 for generation of the content subset criteria 202, according to an embodiment of the present invention;

FIG. 17 illustrates via an example flowchart, an example method 1700, for determining user selected content, according to an embodiment of the present invention;

FIG. 18 illustrates via an example flowchart, an example method 1800, for determining example base content, according to an embodiment of the present invention;

FIG. 19 illustrates via an example flowchart, an example method 1900, for associating the user criteria with the user, according to an embodiment of the present invention;

FIG. 20 illustrates via an example flowchart, an example method 2000, for storing content subsets in an example second bin, according to an embodiment of the present invention;

FIG. 21 illustrates via an example flowchart, an example method 2100, for storing content subsets in an example third bin, according to an embodiment of the present invention;

FIG. 22 illustrates via an example flowchart, a method 2200, for storing content subsets in an example fourth bin, according to an embodiment of the present invention;

FIG. 23 illustrates via an example flowchart, an example method 2300, for storing compatible content subsets in an example fifth bin, according to an embodiment of the present invention;

FIG. 24 illustrates via an example flowchart, an example method 2400, for making content subsets compatible with one another, according to an embodiment of the present invention;

FIG. 25 illustrates via an example flowchart, an example method 2500, for modifying the content subsets and the base content to become compatible with the end user device, according to an embodiment of the present invention;

FIG. 26 illustrates via an example flowchart, an example method 2600, for generating customized content based on the modified base content and the content subsets, according to an embodiment of the present invention;

FIG. 27 is an example high level block diagram of an example network environment 2700 including an example entertainment system 102, according to an embodiment of the present invention;

FIG. 28 is an example high level block diagram of an example network environment 2800 including an example entertainment system 102, according to an embodiment of the present invention; and

FIG. 29 is an example high level block diagram of an example computer system as may be used in various example components of computer devices and systems.

### DETAILED DESCRIPTION OF VARIOUS EXEMPLARY EMBODIMENTS OF THE INVENTION

Exemplary applications of apparatuses, systems, computer program products, and methods according to the present disclosure are described in this section. These examples are being provided solely to add context and aid in the understanding of the disclosure. It will thus be apparent to one skilled in the art that the present disclosure may be practiced without some or all of these specific details. In other instances, well known process steps have not been described in detail in order to avoid unnecessarily obscuring the present disclosure. Other applications are possible, such that the following examples should not be taken as limiting.

In the following detailed description of exemplary embodiments, references are made to the accompanying drawings, which form a part of the description, and in which are shown by way of illustration specific embodiments in which the invention may be practiced. These embodiments are described in sufficient detail to enable those skilled in the art to practice the invention, and it is to be understood that these examples are not limiting, and that other example embodiments may be utilized and logical, structural, physical, electrical, and other changes may be made without departing from the spirit and scope of the present invention.

The present disclosure provides example entertainment systems, computer products, and methods providing customized entertainment to a user, according to an exemplary embodiment. The present invention seeks to illustrate examples of systems, methods and computer program products to provide a user with a customized entertainment experience that is based on that user's unique interests, preferences, traits and characteristics, according to an exemplary embodiment. These embodiments include, for example, but not limited to, demographics, age, race, gender, language and geography, etc., according to an exemplary embodiment The embodiments may also include, for instance, without limitation, personality, opinions, interests, ratings, feedback, awards, successes, lifestyle, and values of the user, etc., according to an exemplary embodiment. And the embodiments may also include, e.g., but not limited to, history of searching, browsing and viewing, history of selections, viewing completion and incompletion history, and purchase history of the user, according to an exemplary embodiment. Exemplary embodiments can also include, e.g., but not limited to, visual and/or audio characteristics of the user, as well as the user's environment, according to an exemplary embodiment. The exemplary embodiments of the present invention may further include seeking to provide a group of users with an entertainment experience that may be customized for that group of users based its collective interests, preferences, traits and characteristics, according to an exemplary embodiment.

Exemplary embodiments recognize that each user is unique. Different users perceive the same book, movie, game or virtual reality simulation differently, according to an exemplary embodiment. Some users may find a book or simulation satisfying while other users may not. The same movie, augmented reality simulation, or audio book, for example, may be perceived as fascinating by a female, who is an athlete and Hindi speaker, but, a different user, who may, e.g., but not limited to, be over 50 years old, have poor hearing or eyesight, resides in a cosmopolitan city in South America, may not find that movie, audio book or virtual reality simulation exhilarating or impactful, according to an exemplary embodiment. Some users, according to an exemplary embodiment, may prefer more romance; other users may prefer more political conspiracy, according to an exemplary embodiment, while other users may seek thrills from choreographed car chases, according to an exemplary embodiment. Slight changes to a movie, music, augmented reality simulation, or audio book, based on a user's unique interests, preferences, traits and characteristics, may result in a more satisfying and rewarding entertainment experience for the user, according to an exemplary embodiment. That is, an improved movie and/or augmented reality simulation, according to an exemplary embodiment, that is slightly customized and personalized for a particular user may, in turn, actually and more meaningfully satisfy a much larger base of users. The more satisfying a user's entertainment experience, is for more users, in turn, results in a more successful movie, augmented reality simulation, or audio book, according to an exemplary embodiment. More success for a movie, computer game, or book, according to an exemplary embodiment, translates into more popularity, earnings and prominence for the content creators and owners. This way, all of: the users, the content creators, and the owners, can win, according to an exemplary embodiment.

A customized entertainment experience does not mean the content creator or owner loses control of his or her work, according to an exemplary embodiment. Rather, the content creator may remain involved in selecting the various other exemplary aspects of the text, audio, video or simulation experience, etc., that may serve as the customized context that a user (or end user) experiences based on that user's (or end user's) characteristics, preferences, or selections, according to an exemplary embodiment. The content creator, according to an exemplary embodiment, may also be a creator of a content subset, according to an exemplary embodiment. The content creator may continue to have a direct impact on the entertainment experience of a wide variety of users, even though each user's experience is somewhat customized for that particular user, according to an exemplary embodiment. This way, the customized aspects of a content creator's exemplary text, audio, video, or simulation is likely to provide an even more satisfying experience to a user, according to an exemplary embodiment, than a conventional static, rigid and un-customized experience, because the user's experience, according to an exemplary embodiment, is customized to his or her implicit or explicit interests, preferences or likings etc. If a group of users exists, the collective preferences and interests of the group of users, according to an exemplary embodiment, can be used to customize the entertainment presented to the group of users, to achieve a more satisfying experience for that group of users, according to an exemplary embodiment. As a result, more individual users, and groups of users, may enjoy the content creator's work as a result of the customization, according to an exemplary embodiment. It is to be understood that the content creator need not also be a creator of a content subset, according to an exemplary embodiment. The creator of a content subset may be a third party not connected to the content creator, according to an exemplary embodiment.

In one example embodiment of the present invention, the content subsets may be provided by the creator of the base content or by a third party, such as a streaming service, or by the user themselves, according to an exemplary embodiment. The creator of the base content could approve a curation of content subsets prepared by a third party, for example, as “Authorized James Bond 007 Adventure Pack,” according to an exemplary embodiment. In another embodiment, the content subsets maybe available for rent, lease or purchase, for instance, from a streaming service for the system to use to customize the base content generated and performed at the end user device, according to an exemplary embodiment. In one embodiment, a user can subscribe, pay or download a collection of content subsets, such as, e.g., but not limited to, an “adventure pack,” “romance pack,” or “historical people pack,” according to an exemplary embodiment. In another embodiment, the user too, may have his or her own content subsets, such as, e.g., but not limited to, “conversation with grandparents,” “Arsh's first day,” “family vacation in the Lakshadweep Islands,” or “Arya's first day in kindergarten,” etc., according to an exemplary embodiment. The system can utilize the variety of content subsets, based on, e.g., among other things, the user criteria, according to an exemplary embodiment. This way, the user can have a virtual reality conversation with living or departed family members, listen to music that includes the first words spoken by his or her child, or watch a James Bond movie that is customized with helicopter, submarine, ski and car stunts scenes complied by, or sold by, a third party, according to an exemplary embodiment.

The present invention, according to an exemplary embodiment, customizes content considering, in part, the end user device capabilities to enhance the user's entertainment experience, according to an exemplary embodiment. For example, the presentation may be made, e.g., but not limited to, in a specific language, displayed with certain type and font size of subtitles, performed at a certain volume level and audio channels, displayed at a certain screen resolution and size and in an environment that has ambiance lighting, temperature and mood capabilities enabled, in order to take advantage of the end user device capabilities and to enhance the user's entertainment experience, according to an exemplary embodiment. Further enhancements, according to an exemplary embodiment, based on user criteria and end user device capabilities, may include, e.g., but not limited to, adjustments to display (e.g., dim/bright, zoom, color scene scheme, projections), audio (e.g., type of surround sound, sound effects, sound level), ambience lighting (e.g., color, brightness, light synchronization with sound effects), tactile feedback (e.g., chairs, goggles, input device), and environment (e.g., humidity, temperature, fragrance), etc., according to an exemplary embodiment.

The system, according to an exemplary embodiment of the present invention, may cater to different types of content, for example, but not limited to, text, audio, graphics, holograms, animation, video, movies, augmented reality content, and virtual reality content, etc., according to an exemplary embodiment. The systems, computer program products, and/or methods described herein are applicable to all types of content, unless context explicitly requires otherwise, according to an exemplary embodiment. For instance, the methods may be described with respect to video content; however, other types of content are within the spirit and scope of exemplary embodiments of the present invention.

For example, when watching a video, at any point of time during the video, a user may be associated with an engagement level of the user with the video content, according to an exemplary embodiment. The engagement level may indicate an exemplary satisfaction level of the user with the video at that point of time, according to an exemplary embodiment. If the engagement level is below threshold level, the entertainment system may take action so that engagement level of the user is improved in real time, thereby providing a more satisfying experience to the user, according to an exemplary embodiment. If the engagement level of the user is equal to or above threshold level, according to an exemplary embodiment, then the video may be continued without any modification, according to an exemplary embodiment. This engagement level may apply to other content as well, such as, for example, virtual reality simulations, music and computer games, etc., according to an exemplary embodiment.

The system, according to an exemplary embodiment, may employ artificial intelligence methods to determine the engagement level of the user and providing more satisfying experience to the user by modifying the content, through the addition or substitution of content subsets, in real time. The engagement level of the user for a portion of the video content may be different from the engagement level of the user for a different portion of the same video content, according to an exemplary embodiment. Engagement level of the user may be determined and assigned to each portion of the content of predetermined duration, according to an exemplary embodiment. For example, each example five (5) minute portion of the video may be assigned an engagement level of the user, according to an exemplary embodiment. The video, according to an exemplary embodiment, may be modified based on the current engagement level of the user.

Engagement level may be determined based on one or more parameters or one or more, real time or historical, user actions, according to an exemplary embodiment. For example, one or more parameters may be eye movements, laughter, speech, rate of breathing, rate of perspiration, pulse rate, and lying or sitting position of the user, according to an exemplary embodiment. One or more actions can be haptic gesture by the user or an input by the user to the system, according to an exemplary embodiment. The frequency and length of changes to the volume, channels, pausing or rewinding, velocity of gestures and bodily movements may reflect the user engagement level, according to an exemplary embodiment.

The content may be modified by adding, removing, or editing, to the content, according to an exemplary embodiment. Adding to the content may involve adding or replacing one or more content subsets to a base content so that a customized content having a high engagement score is generated and provided to the user to experience, according to an exemplary embodiment.

Adding the one or more content subsets to the base content may involve step of selection of the one or more content subsets from the plurality of content subsets available in the plurality of content, according to an exemplary embodiment. The plurality of content may include a plurality of base content and a plurality of content subsets, according to an exemplary embodiment. Selection of the base content from the plurality of base content may be mainly based on real time or stored user selection and/or explicit user input, according to an exemplary embodiment. However, the selection of the one or more content subsets from the plurality of content subsets is performed automatically without any additional explicit input of the user, according to an exemplary embodiment.

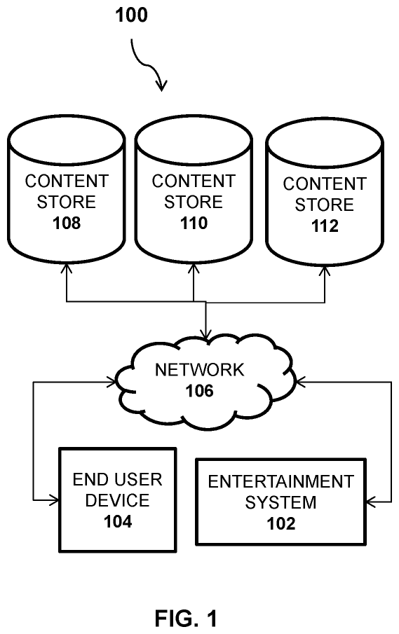

FIG. 1, according to an exemplary embodiment, illustrates an example high level block diagram of a network environment 100 including an entertainment system 102, according to an embodiment of the present invention. The system 102, according to an exemplary embodiment, is communicatively coupled to an end user device 104 and one or more content stores 108, 110, and 112, via a network 106, according to an exemplary embodiment. In this embodiment, the system 102 retrieves content from the content stores, applies various criteria to the content to generate customized content, according to an exemplary embodiment. The customized content is provided to the end user device 104 for consumption by a user, according to an exemplary embodiment.

The system, according to an exemplary embodiment, may generate and present customized content to a user. The system includes a memory having stored thereon a user criteria and a plurality of content. The plurality of content may include, e.g., but not limited to, one or more of text, images, audio, animations, games, augmented and/or virtual reality simulations, graphics, holograms, three dimensional visuals, video and/or movies, etc. The memory is communicatively coupled to one or more processor(s) in an example embodiment. The processor, according to an exemplary embodiment, may be configured for determining a base content from a plurality of content, based at least in part on user criteria, according to an exemplary embodiment. The processor may be further configured for determining one or more content subsets based on at least one of the user criteria and the metadata associated with the base content, according to an exemplary embodiment. The processor may select one or more content subsets based on at least one or more of the user criteria and/or device criteria, etc., according to an exemplary embodiment. The processor may process the base content and the one or more content subsets, according to an exemplary embodiment. The processor may process the content, and, e.g., but not limited to, preferably, without additional user input, generate a customized content comprising, e.g., but not limited to, the base content and/or the one or more content subsets, etc., for an end user device, according to an exemplary embodiment. The processor may transmit said customized content to the end user device, according to an exemplary embodiment. The customized content may be presented for display at the end user device, according to an exemplary embodiment.

In one embodiment, the memory, according to an exemplary embodiment, may comprise a distributed and/or network connected database, according to an exemplary embodiment. In one embodiment, the system, according to an exemplary embodiment, may reside on at least one end user device. In another embodiment, the system may reside on a distributed cloud system and may be communicatively coupled to the end user device through an example distributed network, according to an exemplary embodiment, including a content delivery network, according to an exemplary embodiment. In one embodiment, where some of the content subsets may be stored in the cloud, some content subsets may be geographically spread out using CDN technology, according to an exemplary embodiment. The one or more hardware or software processors, in the cloud or on the end user device, according to an exemplary embodiment, may process the customized content and, the base content and content subsets may be transmitted from the system and/or from distributed and/or networked memories and/or merged and/or presented at the end user device, according to an exemplary embodiment. In another embodiment, where the content subsets are stored on the end user device, e.g., but not limited to, the base content and/or content subsets, according to an exemplary embodiment, may be transferred to the system on the end user device where the base content and content subsets may be merged and/or may be presented as customized content to the user, according to an exemplary embodiment. In yet another embodiment of the invention, certain content may be stored on the distributed ledger, such as, e.g., but not limited to, one or more blockchains, etc., according to an exemplary embodiment.

In one embodiment of the present invention, the system may include an example artificial intelligence agent, according to an exemplary embodiment. The artificial intelligence agent, according to an exemplary embodiment, may be configured to determine the customized content based on the base content, one or more content subsets, and/or the content subset criteria, according to an exemplary embodiment. The content subset criteria may be determined based on at least one or more of the user criteria, the device criteria, the ambience criteria, and/or the content criteria, etc., according to an exemplary embodiment. The user criteria may include one or more of user physical factors 1002, cognitive factors 1004, social factors 1006, political factors 1008, economic factors 1010, consumption factors 1012, cultural factors 1014, geographic factors 1016, educational factors 1018, activity factors 1020, and/or other factors 1022, etc., according to an exemplary embodiment. The device criteria may include at least one or more of, e.g., but not limited to, a type of device, software and/or hardware capabilities, audio and/or video capabilities, processing capabilities and/or communication and/or network capabilities, etc., according to an exemplary embodiment. In one embodiment, the end user device may include at least one or more of, e.g., but not limited to, an electronic book, a tablet, a speaker, an earphone, a smart speaker, a smart phone, a augmented reality glasses, a virtual reality headset, a monitor, a display, a smart TV, an audio and/or video system, a stereo system, a projector, a network connected lens(es) and/or helmet, and/or pop up screen display, etc., according to an exemplary embodiment. In a different embodiment, the end user device may be one or more hardware and/or software devices that may work in combination, or coordination, providing, e.g., but not limited to, a visual display, such as, e.g., but not limited to, VR goggles, and/or a TV, with e.g., but not limited to, audio using speakers and/or earphones, and/or tactile and/or sensory feedback using, e.g., but not limited to, positional platforms that may include, e.g., but not limited to, ambient temperature, olfactory and/or vibration sensory capabilities, etc., according to an exemplary embodiment. The system may further include, e.g., but not limited to, a content encoder, a content decoder, a multiplexer, a de-multiplexer, and a transcoder, etc., according to an exemplary embodiment. In some embodiments, the system may include, e.g., but not limited to, a digital rights management (DRM) module for managing, e.g., but not limited to, copyrights, trademarks, patents, and/or other intellectual property (IP) rights associated with the plurality of content, according to an exemplary embodiment. In one embodiment, the plurality of content may be stored on a cloud system and the customized content may be generated on the cloud system and transmitted to the end user device in real time, according to an exemplary embodiment.

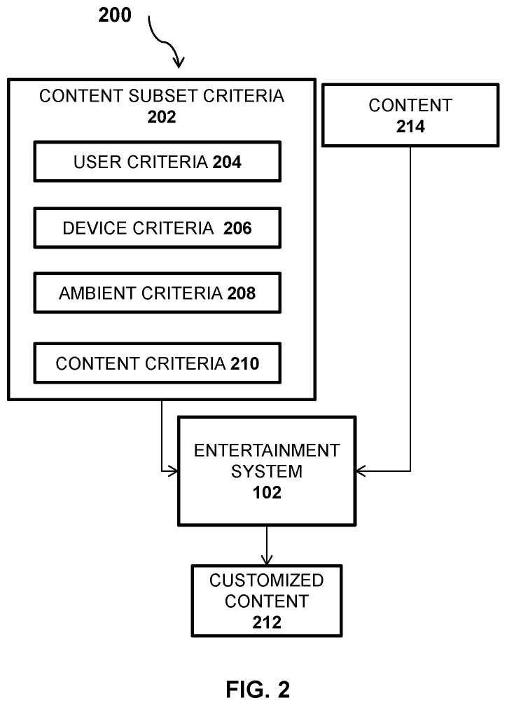

FIG. 2 illustrates high level flow diagram 200 including the entertainment system 102, according to an embodiment of the present invention. The system 102, according to an exemplary embodiment, retrieves content 214 and applies content subset criteria 202 to the content 214, and generates customized content 212. In this embodiment, the content subset criteria may include but not limited to user criteria 204, device criteria 206, ambient criteria 208, and content criteria 210. In one embodiment of the present invention, content 214, content subset criteria 202 and/or customized content 212 may be stored on a distributed ledger, such as, one or more blockchains, according to an exemplary embodiment.

The user criteria may include, e.g., but not limited to, one or more factors associated with the user, according to an exemplary embodiment. Each of the one or more factors may be assigned a weight. For example, age of the user and geographic location of the user may be two factors constituting the user criteria for the user. In some embodiments, the age of the user may be assigned more weight than the weight assigned to the geographic location of the user. To take this example further, when the system selects the base content or the one or more content subsets, metadata or other information associated with the content may be extracted, according to an exemplary embodiment. The extracted information may indicate that the content is liked by users of age 50 and above and the content is liked by only 40 percent of the users located in Kashmir, India, according to an exemplary embodiment.

The system may assign an engagement score to the content, according to an exemplary embodiment. The engagement score may be from 1 to 100, according to an exemplary embodiment. A higher engagement score may mean that the user may like and feel satisfied with the content, according to an exemplary embodiment. Rules may be framed stipulating that the content having an engagement score of 91 or above must be presented to the user, according to an exemplary embodiment.

The engagement score, according to an exemplary embodiment, may include a function of the user criteria and/or the content criteria, etc. The content criteria may include, according to an exemplary embodiment, metadata of the content. The metadata may include historical data, according to an exemplary embodiment. Historical data may include, e.g., but not limited to, age and/or location of other users, etc., who have liked the content previously, according to an exemplary embodiment.

If, according to an exemplary embodiment, the historical data indicates that 70% of the users aged 50 or falling in the corresponding age group of the user have liked the content, the age factor for the user may be assigned a weight of 0.7. Further, the historical data may indicate that 60% of the users who live in Srinagar liked the content; the location factor for the user may be given a weight of 0.6, according to an exemplary embodiment. Further, metadata may indicate that the content is directed by Director A, and content criteria may indicate that any content directed by Director A has been liked by 80% of the users; the director factor for the user may be assigned a weight of 0.8, according to an exemplary embodiment.

Each factor included in the user criteria, according to an exemplary embodiment, may have a score of 1 and each factor not included in the user criteria has a score of zero (0).

The engagement score of the content for the user, according to an exemplary embodiment, is determined by weighted summation of the scores for the factors and corresponding weights assigned to the factors. In the above example, the engagement score (ES) is determined as: 100*(1*0.7+1*0.6+1*0.8)/3 that is 70, according to an exemplary embodiment. The content should not be presented to the user here, for example, because the engagement score is below 91, specified in the rule described above, according to an exemplary embodiment.

In a generalized embodiment, for a user, the user criteria may include factors F1 through FN, corresponding weights may be W1 through WN, the engagement score may be obtained by weighted summation of factors F1 through FN, where N is a natural number, according to an exemplary embodiment. A weight Wi of a factor Fi for a user Ui for a content Ci, according to an exemplary embodiment, may be based on historical data, and/or it may be based on machine learning, etc.

For example, where a new factor education of the user is introduced in the user criteria, but there is no historical data available correlating the education of users with the content, the system may learn to assign weight to the education factor, according to an exemplary embodiment. Content consumption of the users based on existing factors may be monitored by the system, according to an exemplary embodiment. Complete consumption of the content in a single sitting without skipping or pausing may be a good indicator that the content is liked by the user, according to an exemplary embodiment. Education level of the user who has consumed the content may be tagged with the content consumed as content liked by the consumer of that education level, according to an exemplary embodiment. Similarly, if a user abandons the content in between or skips the content while consuming the content, it is a good indicator that the content is not liked by the user or poorly liked by the user, according to an exemplary embodiment. This information of ‘not liked’, or ‘poorly liked’, or any other tag may be associated with the content along with the education level of the user, according to an exemplary embodiment. Training data may also be fed to the system with education level variable, according to an exemplary embodiment. When sufficient data has been collected, weight of the education factor may be determined based on the number of the users who have liked the content, according to an exemplary embodiment. For example, if out of 1000 users who have consumed the content, 700 have liked it, and out of those 700 who have liked it, 400 users have education level L1, then for a user with an education level L1, the weight to be assigned to the education factor may be determined as 400/700, that is 0.56, according to an exemplary embodiment.

In another embodiment of the present invention, customized entertainment may be provided to a group of users. The group of users may contain two or more users using the same end user device or different end user devices that are synchronized to present the same content, according to an exemplary embodiment. Customized entertainment may be provided to the group of users based on common characteristics and preferences of the users in the group, according to an exemplary embodiment. As illustrated by the above example, for a group of users who want to consume the content together, a group engagement score (GES) may be determined by taking weighted summation for all the factors for all the users, according to an exemplary embodiment. However, a content having an engagement score of 71 or above, may be presented to the group, as it is likely that a higher GES may not be obtained for most of the available content, according to an exemplary embodiment. However, some groups may be so similar in their interests and preferences, that a higher GES may be appropriate, according to an exemplary embodiment.

Sometimes users may not have any interest in the available content, such as, e.g., but not limited to, when a user endlessly scrolls through a streaming service's menu, etc., according to an exemplary embodiment. It may happen, according to an exemplary embodiment, that none of the available content has a threshold engagement score for the user. The user, according to an exemplary embodiment, may be unsatisfied with the content, and may move on to another entertainment or content service provider. The user may switch, for example, from HBOMax to Amazon Prime, according to an exemplary embodiment. Systems and methods available in the conventional state of the art unfortunately fail to overcome the above problems.

The present invention, according to an exemplary embodiment, may address and/or overcome the above shortcomings of the state of the art by providing systems and methods that generate and present customized content to the satisfaction of the user.

To improve the satisfaction level of the user with the customized content, the customized content may be generated based on the base content and one or more content subset, according to an exemplary embodiment. The base content and the content subsets, according to an exemplary embodiment, must be determined, based on various criteria already specified, to provide a higher likelihood of a satisfying entertainment experience for the user.

In one embodiment, the determination of the content subset may be based at least in part on user criteria. The user criteria may include but are not limited to, according to an exemplary embodiment, physical factors 1002, cognitive factors 1004, social factors 1006, political factors 1008, economic factors 1010, consumption factors 1012, cultural factors 1014, geographic factors 1016, educational factors 1018, activity factors 1020 and/or other factors 1022 of the user, etc., according to an exemplary embodiment.

To improve the satisfaction level of the user with the customized content, the customized content may be generated, according to an exemplary embodiment, based on the base content and one or more content subsets. As the base content is predetermined, the content subset, according to an exemplary embodiment, must be found which when combined with the base content provide a higher likelihood of a satisfying entertainment experience to the user.

In one embodiment, the determination of the content subset may be based at least in part on device criteria. The device criteria, according to an exemplary embodiment, are characteristics and properties of the end user device that is used by the user for access and consumption of the content.

In one embodiment, the device criteria may include hardware and software capabilities such as, e.g., but not limited to, projector display type, size and/or resolution, memory type and/or capacity, storage type and/or capacity, processor power, audio and/or video sound system capabilities, headphone and/or speakers, operating system, application used for content access, communications capability of the device, and/or network bandwidth available to the device.

In one embodiment, the determination of the content subset may be based at least in part, according to an exemplary embodiment, on ambient criteria. The ambient criteria, according to an exemplary embodiment, may include characteristics and/or properties of the location of the user at the time of consumption of the content. In one embodiment, the ambient criteria may include, e.g., but not limited to, lighting, temperature, wind speed, humidity, weather, and/or ambient noise at the location, etc., according to an exemplary embodiment. The ambient criteria may further include, e.g., but not limited to, factors such as indoor or outdoor environment, whether the user is at home, at office, at a party, at vacation home, and/or in a meeting, waiting, and/or travelling, etc., according to an exemplary embodiment.

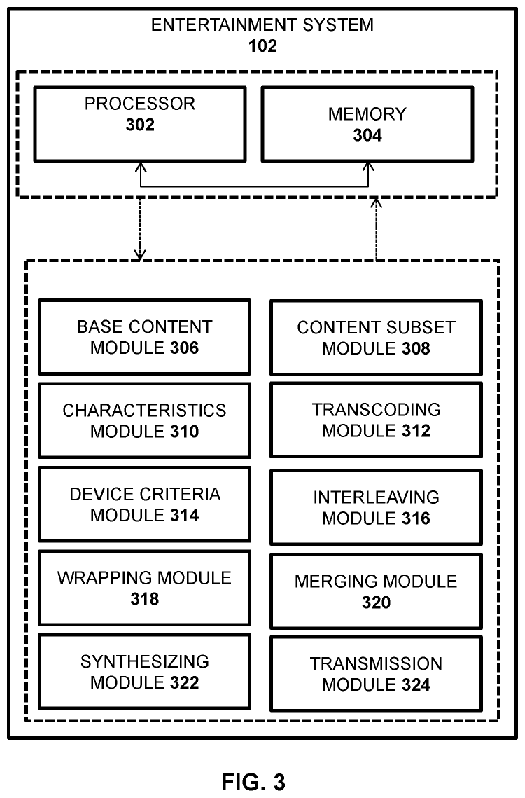

FIG. 3 illustrates high level block diagram of the entertainment system 102, according to an embodiment of the present invention. The system 102 may include, e.g., but not limited to, a processor 302 communicatively coupled to a memory 304 and/or one or more modules 306-324, according to an exemplary embodiment. The one or more modules 306-324, according to an exemplary embodiment, may include a base content module 306 that determines a base content to be customized. A content subset module 308 may determine one or more content subsets to be added to the base content for the customization. A characteristics module 310, according to an exemplary embodiment, may determine compatibility among the base content and/or the one or more content subsets, according to an exemplary embodiment. A transcoding module 312, according to an exemplary embodiment, may transcode the one or more incompatible content subsets to make them compatible with the base content. A device criteria module 314, according to an exemplary embodiment, may make the base content and the one or more content subsets compatible with the end user device 104. An interleaving module 316, according to an exemplary embodiment, may determine a sequence or order of the content subsets that are to be added to the base content. A wrapping module 318, according to an exemplary embodiment, may wrap the base content and the one or more content subsets for transmission based on a deployed transmission protocol. A merging module 320, according to an exemplary embodiment, may merge the base content with the one or more content subsets to generate a group of temporally overlapping content. A synthesizing module 322, according to an exemplary embodiment, may synthesize the group of temporally overlapping content into a customized content. A transmission module 324, according to an exemplary embodiment, may transmit the customized content to the end user device 104 for presentation.

In another embodiment, a method of generating and presenting customized content to a user is disclosed, the method comprising, using one or more processors for determining, according to an exemplary embodiment, a base content from a plurality of content, based at least in part on a user criterion, or criteria. Determining, according to an exemplary embodiment, one or more content subsets based on at least one of the user criteria and the metadata associated with the base content. Selecting, according to an exemplary embodiment, one or more content subsets based on at least one of the user criteria and device criteria. Processing, according to an exemplary embodiment, the base content and the one or more content subsets. Generating, according to an exemplary embodiment, on the fly without explicit user input, a customized content may include, e.g., but not limited to, the base content and the one or more content subsets for an end user device. Transmitting, according to an exemplary embodiment, said customized content to the end user device and, according to an exemplary embodiment, presenting said customized content configured for display at the end user device.

In one embodiment, the determining the base content may include storing the user criteria in a database, wherein the user criteria include, according to an exemplary embodiment, at least one or more of, e.g., but not limited to, user physical factors 1002, cognitive factors 1004, social factors 1006, political factors 1008, economic factors 1010, consumption factors 1012, cultural factors 1014, geographic factors 1016, educational factors 1018, activity factors 1020, and/or other factors 1022, etc. Storing, according to an exemplary embodiment, a plurality of content in an example electronic database, wherein the plurality of content may include, e.g., but not limited to, at least one or more of text, images, audio, animations, music, holograms, graphics, three dimensional visuals, simulations, movies, and/or video, etc. Accessing, according to an exemplary embodiment, user selected content from said plurality of content, to determine base content, may be based in part on receiving, e.g., but not limited to, an explicit input from the user, wherein said input may include at least one or more of, e.g., but not limited to, a title of a book, and/or a name of a book, a movie, a game, a band, and/or a name of, e.g., but not limited to, a director, an author, an artist, an actor, and/or a performer of the user selected content, etc. Accessing, according to an exemplary embodiment, metadata associated with the user selected content and/or analyzing the user criteria with the user selected content to determine the base content from the plurality of content. The electronic database, according to an exemplary embodiment, may be a distributed and/or network connected electronic database.

Determining, according to an exemplary embodiment, the one or more selected content subsets may include, e.g., but not limited to, analyzing the metadata associated with the base content, analyzing the metadata associated with the one or more content subsets, analyzing the compatibility of the base content with the one or more content subsets, identifying one or more content subsets based on a correlation between the user criteria and the one or more content subsets; and/or analyzing the user criteria with the one or more content subsets to determine the one or more selected content subsets, etc.

In one embodiment, processing the base content and the one or more selected content includes correlating each of the one or more selected content subsets with the base content. The processing, according to an exemplary embodiment, may further include determining a characteristic of each of the one or more selected content subsets with the base content and a characteristic of each of the one or more content subsets with others of the one or more selected content subsets based on at least one or more of: e.g., but not limited to, a data signature, a fingerprint code, a timestamp, and/or a metadata of the base content, and/or the at least one or more selected content subsets, etc. The processing, according to an exemplary embodiment, may further include transcoding the one or more selected content subsets for compatibility with the base content.

In another embodiment of the present invention, the metadata may be time-synchronized. Where the metadata is time-synchronized, the end user device can use the metadata information to match the one or more content subsets with the base content, to form the customized content, according to an exemplary embodiment. The metadata, for example, but not limited to, can represent a position of a specific frame within a video such that it can be property positioned within the base content, according to an exemplary embodiment.

In one embodiment, generating, according to an exemplary embodiment, without user input, the customized content may include, e.g., but not limited to, receiving the device criteria of the end user device, wherein the device criteria include at least one or more of, e.g., but not limited to, a type of device, software and/or hardware capabilities, audio and/or video capabilities, processing capabilities and/or communication capabilities, etc. Generating, according to an exemplary embodiment, may further include, e.g., but not limited to, processing the base content and the one or more selected content subsets based on the device criteria. Interleaving, according to an exemplary embodiment, characteristics of the base content and the one or more selected content subsets may be determined based on at least one or more of: e.g., but not limited to, the user criteria, the device criteria, the ambient criteria and/or the content criteria, etc. The base content and/or the one or more selected content subsets are wrapped for transmission to the end user device, according to an exemplary embodiment. The base content and/or the at least one or more selected content subsets may be merged into a group of temporally overlapping content, according to an exemplary embodiment. The group of temporally overlapping content may then be synthesized, according to an exemplary embodiment, into a customized content. In another embodiment of the present invention, generating of the customized content may be done with explicit input of the user provided in, e.g., but not limited to, real time, near-real time, and/or with a limited delay, etc. In a separate embodiment, generating of the customized content, according to an exemplary embodiment, may be based on information stored in the system that is associated with the user or the user criteria.

In one embodiment, determining the base content comprises, according to an exemplary embodiment, determining the user criteria based on, e.g., but not limited to, the stored user input, user information obtained in real-time using artificial intelligence and/or machine learning techniques, user information determined from merging and/or weighting of user criteria associated with two or more users, etc.

In one embodiment, the physical factors associated with a user may include, according to an exemplary embodiment, e.g., but not limited to, age, gender, height, weight, eyesight abilities, hearing abilities, physical mobility, disabilities, and/or other physical health attributes of the user, etc.

In one embodiment, the consumption factors associated with the user include at least one or more of a public and/or private information associated with the activity of the user including, e.g., but not limited to, content created or consumed, such as, e.g., but not limited to, purchase history, library activity, social media activity, internet viewing activities, posted reviews, posts created, liked shared and/or recommended, and/or recommendations, etc., wherein the consumption factors may be determined automatically by a system using, e.g., but not limited to, artificial intelligence and/or machine leaning methods, etc.

In one embodiment, wherein the ambience criteria, according to an exemplary embodiment, include, e.g., but not limited to, at least one or more of: a type of the end user device, processing, audio, video, sound and/or resolution capabilities, communications and/or network connectivity of the end user device, the light and/or acoustic characteristics at the location of the end user device, and/or the temperature and/or humidity at the location of the end user device, etc.

In one embodiment, storing the user criteria, according to an exemplary embodiment, may include, e.g., but not limited to, storing information directly entered by the user, storing information obtained through public sources associated with the user to ascertain the user preferences using an artificial intelligence method or a machine learning method, and/or storing an input based on the human machine interface method, etc. In one embodiment, the human machine interface method may include, e.g., but not limited to, providing an input to the end user device based on at least one or more of: a gesture from a user, facial expression of the user, brain activity of the user, eye movement of the user, and/or an audio and/or sound generated by the user. In one embodiment, the presentation of the customized content, according to an exemplary embodiment, may occur on the end user device following the transmission from distributed content storage systems. The end user device, according to an exemplary embodiment, may be at least one or more of: an electronic book, a tablet, a smart speaker, a headphone, a smart phone, an augmented reality display, and/or a virtual reality display, a monitor, a display, a stereo system, a projector(s), a network connected lens(es) and/or helmet(s), and/or pop-up screen display(s), head up display (HUD), etc.

In one embodiment, the storing, according to an exemplary embodiment, of the plurality of content comprises tagging of the plurality of content with predetermined or real-time information, the information including at least one or more of: a start scene, and/or stop scene, actor, author, artist, singer, director, theme, ratings, user metrics, content resolution, length, language, audio characteristics, and/or time stamps, etc. In one embodiment, accessing of the selected content comprises, e.g., but not limited to, receiving a selection of content, wherein receiving the selection of the content, according to an exemplary embodiment, comprises, e.g., but not limited to, providing an input to the end user device based on at least one of inputting a text string, selecting an icon, a gesture from a user, facial expression of the user, neural activity of the user, eye movement of the user, audio sound generated by the user and an input based on a wish list of the user, based on artificial intelligence or machine learning techniques, wherein the wish list comprises content from the plurality of content associated with profile of the user that is tagged as at least one of, ‘to watch later’, ‘interesting content to explore later’, ‘to be shared with another user’, ‘to be flagged to authorities’, to be shared in user's personal group of friends', ‘listen next time’, ‘watch when exhausted’, ‘watch when lonely’, ‘play on the weekend’, ‘meet this person in a simulation’, or ‘visit this place next in a simulation’, ‘go back to the high school prom simulation’, and/or ‘spend time with grandparents simulation’, etc.

In one embodiment, the processing, according to an exemplary embodiment, comprises, e.g., but not limited to, determining an order sequence and/or in which the one or more selected content subsets are to be inserted into the base content to generate the customized content, etc. In one embodiment, the processing comprises, according to an exemplary embodiment, determining a compatible insertion location at the beginning, within, and/or at an end of the base content for each of the one or more selected content subsets to be inserted into the base content to generate the customized content, according to an exemplary embodiment. In one embodiment, the presenting, according to an exemplary embodiment, may include, e.g., but not limited to adapting the insertion of selected content subsets into the base content based on real-time bandwidth connection characteristics of the end user device.

In one embodiment, the insertion location, according to an exemplary embodiment, is determined using an artificial intelligence or a machine learning method. In one embodiment, the machine learning method may comprise, e.g., but not limited to, one of a supervised learning method, an unsupervised learning method or reinforcement learning method. The machine learning method, according to an exemplary embodiment, may comprise one or more of, e.g., but not limited to, linear regression, logistic regression, decision tree, support vector machine (SVM), naive bayes, k-nearest neighbors (kNN), k-means clustering, random forest, dimensionality reduction, and/or gradient boosting algorithm, etc.

In one embodiment, the processing, according to an exemplary embodiment, comprises, e.g., but not limited to, inserting one or more selected content subsets into the base content based on a score for each content subset, wherein the score is determined based on weighted summation of user criteria score of two or more users, etc. In one embodiment, the base content is a live video stream and the one or more selected content subsets may comprise, e.g., but not limited to, stored text, image, audio, video, animation, graphics, augmented reality and/or virtual reality content, etc. In one embodiment, the base content and/or the one or more selected content subsets, according to an exemplary embodiment, may be, e.g., but not limited to, streamed to the end user device using a content delivery network (CDN).

In one embodiment, a non-transitory computer program product for generating and presenting customized content to a user is disclosed. The computer program product, according to an exemplary embodiment, when executed by at least one electronic computer processor, said computer program product may include program code instructions, which when executed configure the at least one electronic computer processor to determine a base content from a plurality of content, based at least in part on user criteria. The computer program product, according to an exemplary embodiment, may include program code instructions to determine one or more content subsets based on at least one of the user criteria and the metadata associated with the base content. The computer program product, according to an exemplary embodiment, may include, e.g., but not limited to, code to select one or more content subsets based on at least one of the user criteria and a device criteria. The computer program product, according to an exemplary embodiment may include program code instructions, which when executed cause the at least one electronic computer processor to be configured to process the base content and the one or more content subsets. The computer program product, according to an exemplary embodiment may include, e.g., but not limited to, code to generate, with or without user input, a customized content comprising the base content and/or the one or more content subsets for an end user device. The computer program product, according to an exemplary embodiment may include program code instructions to transmit said customized content to the end user device and present said customized content at the end user device.

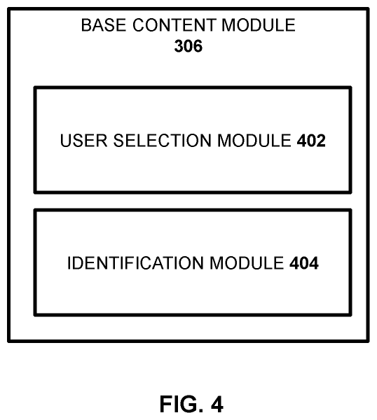

FIG. 4 illustrates through a block diagram the base content module 306, according to an embodiment of the present invention. The base content module may include, according to an exemplary embodiment, a user selection module 402 and an identification module 404. The user selection module 402 selects a plurality of base contents from the content based on a user input or selection. The identification module, according to an exemplary embodiment, may identify one base content to be customized from the plurality of base contents.

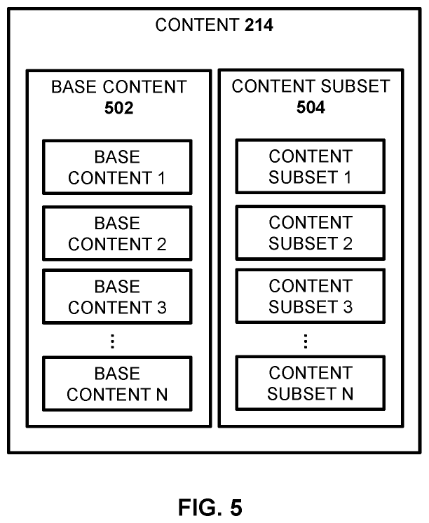

FIG. 5 illustrates through a block diagram the content 214, according to an embodiment of the present invention. The content 214, according to an exemplary embodiment, may include a plurality of base contents 502, base content 1 through base content N, where N is a natural number. The content 214 may include, according to an exemplary embodiment, a plurality of content subsets 504, content subset 1 through content subset N, where N is a natural number.

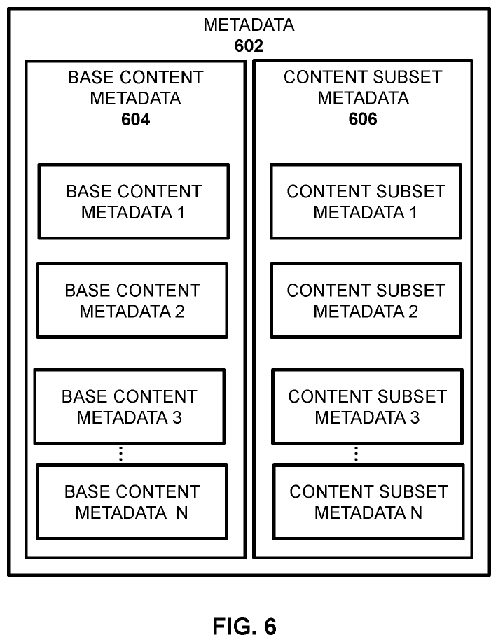

FIG. 6 illustrates through a block diagram metadata 602, according to an embodiment of the present invention. The metadata 602 may include, according to an exemplary embodiment, a plurality of base content metadata 604, base content metadata 1 through base content metadata N, where N is a natural number. The metadata 602 may include, according to an exemplary embodiment, a plurality of content subset metadata 506, content subset metadata 1 through content subset metadata N, where N is a natural number. Generally, metadata is data about another data, according to an exemplary embodiment. In other words any data which describes another data is called metadata, according to an exemplary embodiment.

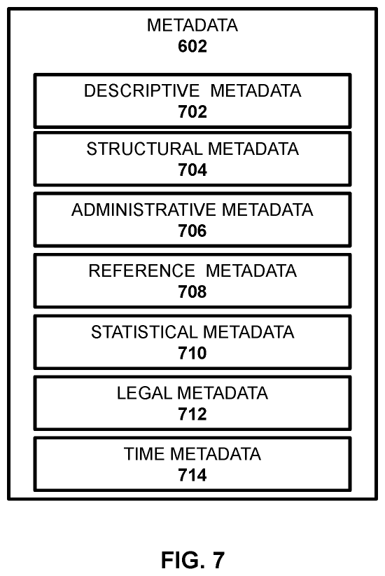

FIG. 7 illustrates through a block diagram types of metadata 602, according to an embodiment of the present invention. The metadata 602, according to an exemplary embodiment, can be any of one or more of various types, including, e.g., but not limited to, descriptive metadata 702, administrative metadata 704, structural metadata 706, reference metadata 708, statistical metadata 710, legal metadata 712, and/or time metadata 714, etc.

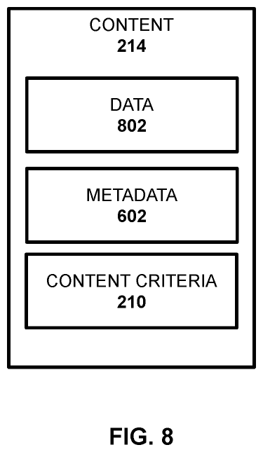

FIG. 8 illustrates through a block diagram, elements of content 214, according to an embodiment of the present invention. The content 214, according to an exemplary embodiment, may include, e.g., but not limited to data 802, metadata 602, and/or the content criteria 210, etc.

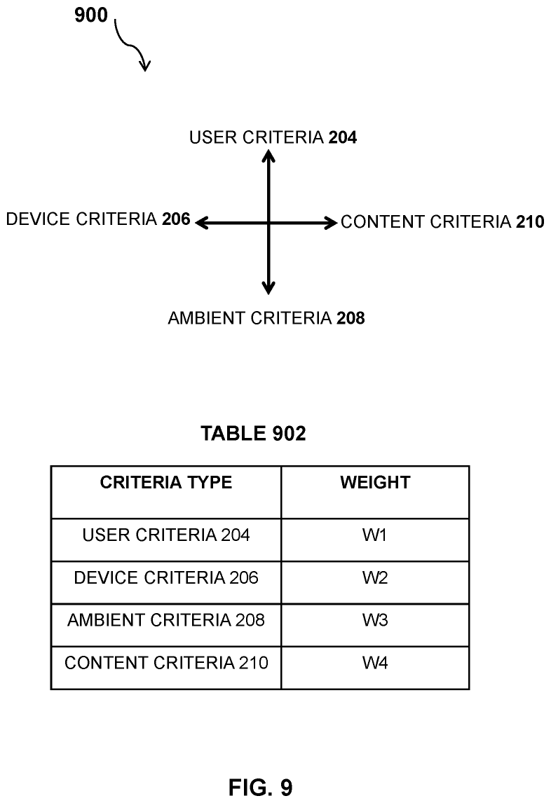

FIG. 9 illustrates a multidimensional vector space 900 and TABLE 902, according to an embodiment of the present invention. The vector space 900, according to an exemplary embodiment, may include four (4) vectors representing the user criteria 204, the device criteria 206, the ambient criteria 208, and/or the content criteria 210, etc. The vectors interact with one another to generate the content subset criteria 202. In one instance, as seen in TABLE 902, the vectors user criteria 204, the device criteria 206, the ambient criteria 208, and the content criteria 210 may be assigned weights W1, W2, W3, and W4 respectively. Weighted summation of the vectors may generate the content subset criteria 202.

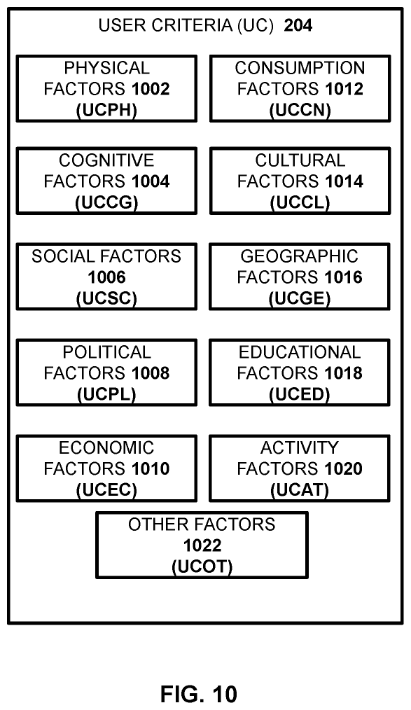

FIG. 10 illustrates through a block diagram, elements of the user criteria (UC) 204, according to an embodiment of the present invention. The UC 204, according to an exemplary embodiment, may be based on at least one or more of: UC physical factors (UCPH) 1002, UC cognitive factors (UCCG) 1004, UC social factors (UCSC) 1006, UC political factors (UCPL) 1008, UC economic factors (UCEC) 1010, UC consumption factors (UCCN) 1012, UC cultural factors (UCCL) 1014, UC geographic factors (UCGE) 1016, UC educational factors (UCED) 1018, UC activity factors (UCAT) 1020, and UC other factors (UCOT) 1022, etc. In one embodiment of the present invention, user criteria (UC) may be stored on a distributed ledger, such as, e.g., but not limited to, one or more blockchains, etc.

The physical factors 1002 of a user may include, e.g., but not limited to, age, gender, height, weight, eyesight abilities, hearing abilities, physical mobility, disabilities, and/or other physical health attributes of the user, etc. Physical health of the user, according to an exemplary embodiment, may signify whether the user can hear or see using impaired settings or is allergic to certain substances or whether the user is suffering from physical pain.

The cognitive factors 1004 of the user, according to an exemplary embodiment, may include, e.g., but not limited to, formal education of the user, professional qualification of the user, skills of the user, interests of the user, experience of the user, languages known to the user, sexual preferences of the user, any mental health condition of the user, and/or mood of the user, etc.

The social factors 1006 of the user, according to an exemplary embodiment, may include at least one or more of: social relationships, employment relationships, religion, and/or ethnicity, etc. The social factors 1006, according to an exemplary embodiment, may further include, e.g., but not limited to, relationship with parents, siblings, relatives, neighborhood of upbringing, usual residence, location at the time of content consumption, type of employment or profession, and/or economic status, etc.

The political factors 1008 of the user may include, e.g., but not limited to, political awareness, political membership, political activity, and/or political status, etc., according to an exemplary embodiment.

The economic factors 1010, according to an exemplary embodiment, may include, e.g., but not limited to, income, debt, and/or spending and saving habits, etc.

The consumption factors 1012, according to an exemplary embodiment, may include, e.g., but not limited to, genre preferences, content search history, viewing or consumption history, payment history, a bucket list of the content made by the user, following of actors, directors and/or cast, authors, creators associated with content, comments made on the content, sharing of the content, and/or flagging of the content, etc. Consumption history, according to an exemplary embodiment, may include, e.g., but not limited to, skipping of the content, whether the user consumed the complete content, and/or number of sessions used by the user to complete the content, etc.

The cultural factors 1014, according to an exemplary embodiment, may include, e.g., but not limited to, languages, cultural holidays, customs, and/or speech accents, etc.

The geographic factors 1016, according to an exemplary embodiment, may include, e.g., but not limited to, metropolitan and rural locations, weather, seasons, and/or time zones, etc.

The educational factors 1018, according to an exemplary embodiment, may include, e.g., but not limited to, fluency of languages, vocabulary, education level, and/or familiarity with technology, etc.

The activity factors 1020, according to an exemplary embodiment, may include, e.g., but not limited to, experiences with family and friends, vacation locations, residences, and/or hobbies, etc.

The other factors 1022, according to an exemplary embodiment, may include, e.g., but not limited to, simulations used, awards received, social media activity, and/or public persona, etc.

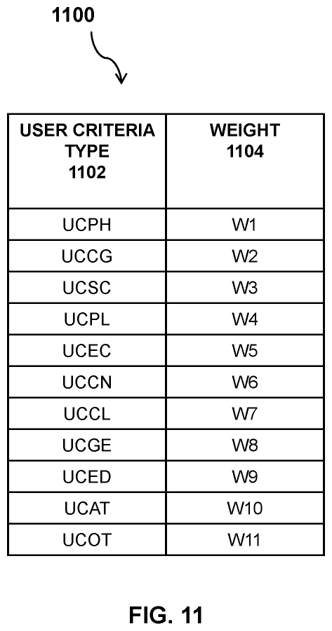

FIG. 11 illustrates a table 1100, according to an embodiment of the present invention. The table 1100, e.g., but not limited to, may include a first column user criteria type 1102 and/or a second column 1104 weight, etc. As seen from the table, e.g., but not limited to, different types of user criteria may be assigned different weights. In one embodiment, e.g., but not limited to, the UCPH, UCCG, UCSC, UCPL, UCEC, UCCN, UCCL, UCGE, UCED, UCAT, UCOT, etc., may be assigned weights W1 through W11 respectively. The weights W1 through W1 may determine respective influence of the above user criteria factors in determining the user criteria 204, according to an exemplary embodiment.

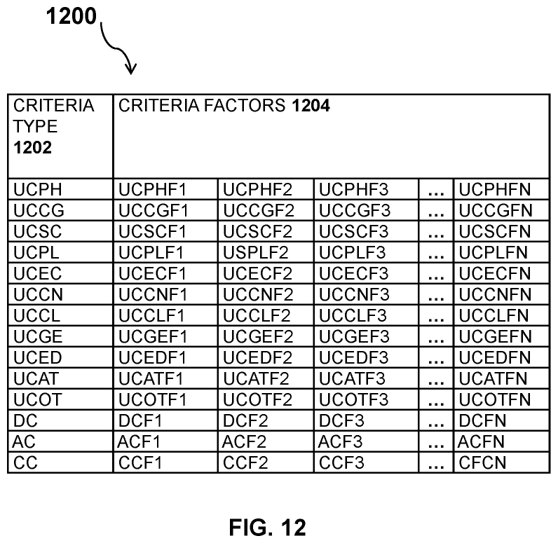

FIG. 12 illustrates a table 1200, according to an embodiment of the present invention. The table 1200, according to an exemplary embodiment, may include first column criteria type 1202 and second column criteria factors 1204. As seen from the table 1200, different types of criteria 1202 are composed of various criteria factors, according to an exemplary embodiment.

For instance the criteria type UCPH (user criteria physical factors), according to an exemplary embodiment, may be comprised of N factors from UCPHF1 (user criteria physical factor 1) to UCPHFN (user criteria physical factor N), where N is a natural number.

Similarly, the criteria type UCCG (user criteria cognitive factors), according to an exemplary embodiment, may be comprised of N number of factors from UCCGF1 (user criteria cognitive factor 1) to UCCGFN (user criteria physical factor N).

The criteria type UCSC (user criteria social factors), according to an exemplary embodiment, may be comprised of N number of factors from UCSCF1 (user criteria social factor 1) to UCSCFN (user criteria social factor N).

The criteria type UCPL (user criteria political factors), according to an exemplary embodiment, may be comprised of N number of factors from UCPLF1 (user criteria political factor 1) to UCPLFN (user criteria political factor N).

The criteria type UCEC (user criteria economic factors), according to an exemplary embodiment, may be comprised of N number of factors from UCECF1 (user criteria economic factor 1) to UCECFN (user criteria economic factor N).

The criteria type UCCN (user criteria consumption factors), according to an exemplary embodiment, may be comprised of N number of factors from UCCNF1 (user criteria consumption factor 1) to UCCNFN (user criteria consumption factor N).

The criteria type UCCL (user criteria cultural factors), according to an exemplary embodiment, may be comprised of N number of factors from UCCLF1 (user criteria cultural factor 1) to UCCLFN (user criteria cultural factor N).

The criteria type UCGE (user criteria geographic factors), according to an exemplary embodiment, may be comprised of N number of factors from UCGEF1 (user criteria geographic factor 1) to UCGEFN (user criteria geographic factor N).

The criteria type UCED (user criteria education factors), according to an exemplary embodiment, may be comprised of N number of factors from UCEDF1 (user criteria education factor 1) to UCEDFN (user criteria education factor N).

The criteria type UCAT (user criteria activity factors), according to an exemplary embodiment, may be comprise of N number of factors from UCATF1 (user criteria activity factor 1) to UCATFN (user criteria activity factor N).

The criteria type UCOT (user criteria other factors), according to an exemplary embodiment, may be comprise of N number of factors from UCOTF1 (user criteria other factor 1) to UCOTFN (user criteria other factor N).

The criteria type DC (device criteria), according to an exemplary embodiment, may be comprise of N number of factors from DCF1 (device criteria factor 1) to DCFN (device criteria factor N).

The criteria type AC (ambient criteria), according to an exemplary embodiment, may be comprise of N number of factors from ACF1 (ambient criteria factor 1) to ACFN (ambient criteria factor N).

The criteria type CC (content criteria), according to an exemplary embodiment, may be comprised of N number of factors from CCF1 (content criteria factor 1) to CCFN (content criteria factor N).

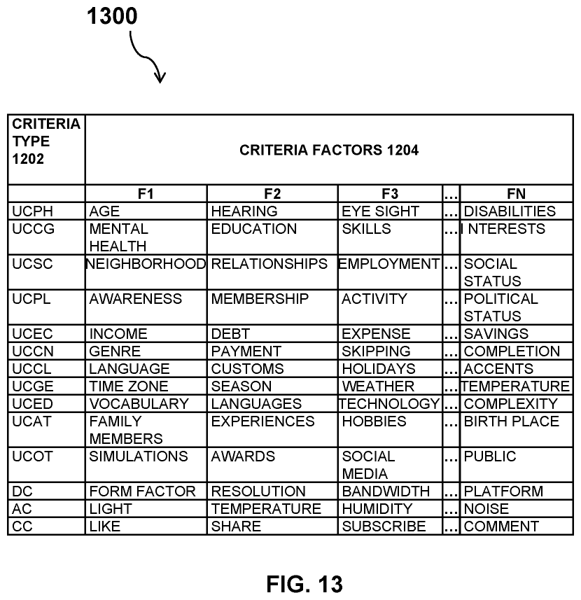

FIG. 13 illustrates a table 1300, according to an embodiment of the present invention. The table 1300, according to an exemplary embodiment, may include first column criteria type 1202 and second column criteria factors 1204. As seen from the table 1300, different types of criteria 1202, according to an exemplary embodiment, may be comprised of various criteria factors F1 through FN, etc. The table 1300, according to an exemplary embodiment, may be similar to the table 1200. The table 1300 may provide, according to an exemplary embodiment, specific examples of factors comprising various criteria types may include, e.g., but not limited to, UCPH, UCCG, UCSC, UCPL, UCEC, UCCN, UCCL, UCGE, UCED, UCAT, UCOT, DC, AC, and/or CC, etc. For instance, UCPH may include, e.g., but not limited to, age, gender, eyesight, and/or of a user, etc., according to an exemplary embodiment. UCCG may include, according to an exemplary embodiment, e.g., but not limited to, mental health, skills, education and/or interest of a user. UCSC may include, e.g., but not limited to, neighborhood, relationship, employment, and/or economic status of a user, etc. UCPL may include, e.g., but not limited to, according to an exemplary embodiment, political awareness, political membership, political activity, and/or political status of a user, etc. UCEC, according to an exemplary embodiment, may include, e.g., but not limited to, income, debt, expenses, and/or savings of a user, etc. UCCN, according to an exemplary embodiment, may include, e.g., but not limited to, genre preferences, payment history, content skipping history, content completion history of a user, etc. UCCL may include, according to an exemplary embodiment, languages, cultural holidays, customs, and/or speech accents, etc. UCGE may include, e.g., but not limited to, metropolitan and rural locations, weather, seasons, and/or time zones, etc. UCED, according to an exemplary embodiment, may include, e.g., but not limited to, fluency of languages, vocabulary, education level and/or familiarity with technology, etc. UCAT, according to an exemplary embodiment, may include, e.g., but not limited to, experiences with family and/or friends, vacation locations, residences, hobbies, etc. UCOT, according to an exemplary embodiment, may include, e.g., but not limited to, simulations used, awards received, social media activity, and/or public persona, etc. Further, DC, according to an exemplary embodiment, may include form factor, resolution, available bandwidth, and/or technology platform of the end user device used by the user, etc. AC, according to an exemplary embodiment, may include, e.g., but not limited to, lighting, temperature, humidity, and/or noise at the location of the end user device, etc. CC, according to an exemplary embodiment, may include, e.g., but not limited to, like, share, subscribe, and/or comments for content, etc.

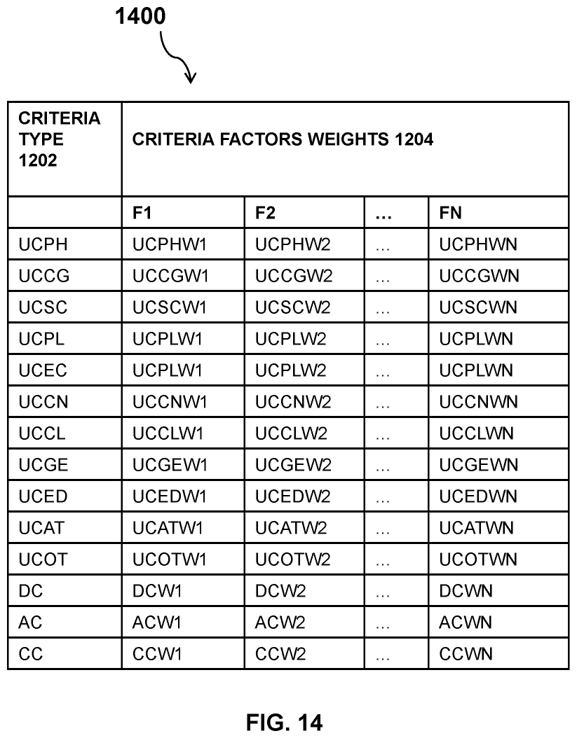

FIG. 14 illustrates a table 1400, according to an embodiment of the present invention. The table 1400, according to an exemplary embodiment, may include first column criteria type 1202; second column criteria factor weights 1204, etc. For instance, user criteria physical factor F1 (UCPHF1, FIG. 12), according to an exemplary embodiment, may be assigned a weight UCPHW, content criteria factor FN (CCFN, FIG. 12) may be assigned a weight CCWN, and so on.

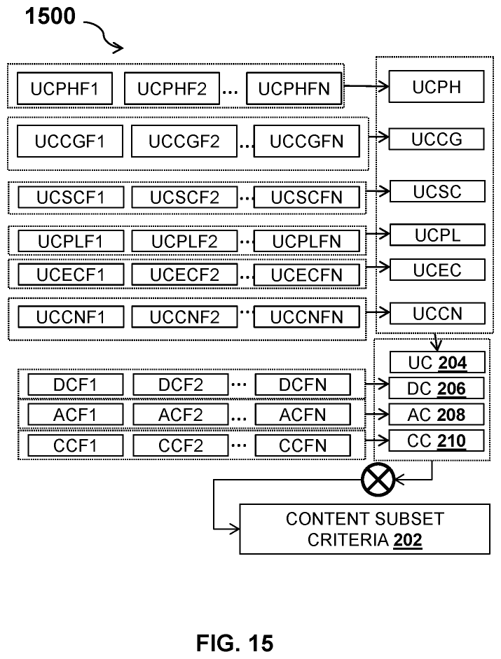

FIG. 15 illustrates a flow diagram 1500 for generation of the content subset criteria 202, according to an embodiment of the present invention. Various physical factors, according to an exemplary embodiment, UCPHF1 through UCPHFN may be combined to generate UCPH. Various cognitive factors, according to an exemplary embodiment, UCCGF1 through UCCGFN may be combined to generate UCCG. Various social factors, according to an exemplary embodiment, UCSCF1 through UCSCFN may be combined to generate UCSC. Various political factors, according to an exemplary embodiment, UCPLF1 through UCPLFN may be combined to generate UCPL. Various economic factors, according to an exemplary embodiment, UCECF1 through UCECFN may be combined to generate UCEC. Various consumption factors UCCNF1 through UCCNFN may be combined to generate UCCN, according to an exemplary embodiment. Various types of criteria, according to an exemplary embodiment, including, e.g., but not limited to, UCPH, UCCG, UCSC, UCPL, UCEC, and/or UCCN may be combined ton generated user criteria UC 204. Similarly various device criteria factors, according to an exemplary embodiment, DCF1 through DCFN may be combined to generate the device criteria DC 206. Various ambient criteria factors, according to an exemplary embodiment, ACF1 through ACFN may be combined to generate the ambient criteria AC 208. Various content criteria factors, according to an exemplary embodiment, CCF1 through CCFN may be combined to generate the content criteria CC 210. Further, UC 204, DC 206, AC 208, and CC 210 may be combined, according to an exemplary embodiment, to generate the content subset criteria 202. In one instance, a weighted summation of UC 204, DC 206, AC 208, and CC 210, according to an exemplary embodiment, may generate the content subset criteria 202.

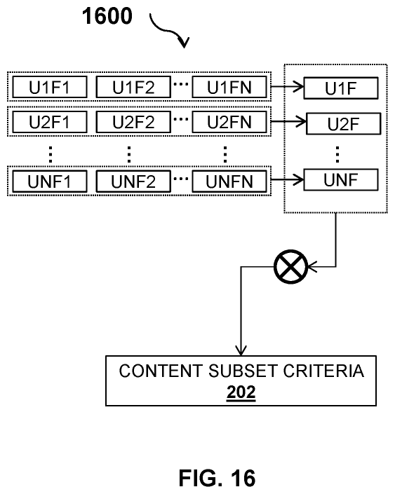

FIG. 16 illustrates a flow diagram 1600 for generation of the content subset criteria 202, according to an embodiment of the present invention. The entertainment system 102, according to an exemplary embodiment, may provide customized content to a group of users based on their common characteristics or preferences. In this embodiment, the common characteristics or preferences of the group of users may be taken into account by generating the content subset criteria 202 using a different methodology than that described with reference to FIG. 15. In this embodiment, the content subset criteria 202 may be generated by combining user factors for users 1 through N. A single value, according to an exemplary embodiment, may be generated for user 1 by combining various user factors for the user 1. Similarly, values may be generated for all users. In FIG. 15, U1F1, according to an exemplary embodiment, represents user factor 1 for user 1 and UNFN represented factor N for user N and so on. U1F represents combined factor for user 1, U2F represents combined factor for user 2, and so on, according to an exemplary embodiment. The content subset criteria 202 may be based on a combination of one or more factors U1F1 through UNFN, according to an exemplary embodiment. In one embodiment, the content subset criteria 202 are generated based in a weighted sum of the U1F to UNF. In another embodiment, factors common to various users are determined and the content subset criteria 202 are generated based on the determined common factors.

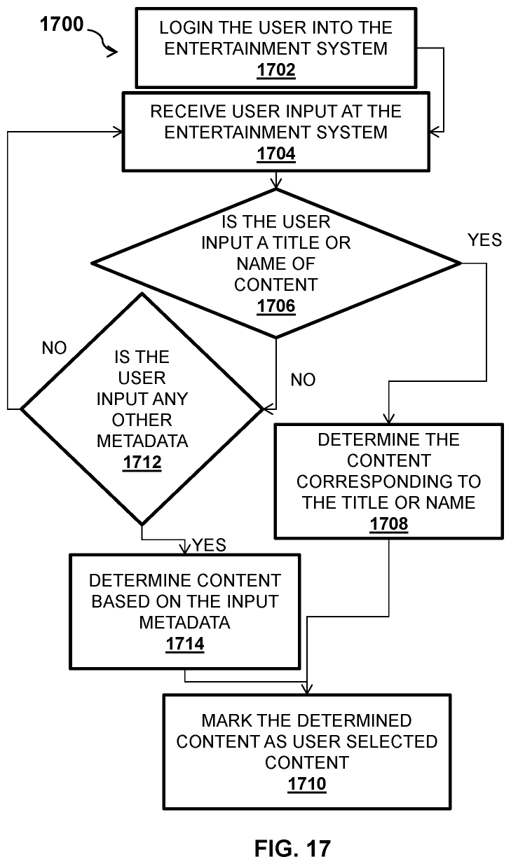

FIG. 17 illustrates via a flowchart, a method 1700, for determining user selected content, according to an embodiment of the present invention. The method 1700, according to an exemplary embodiment, begins at 1702 with a user, actively or passively, logging into the entertainment system 102. The user may login with a user name and password combination or any other known method in the state of the art. Or the user may passively log into the system using saved credentials, a verified and known device or biometrics or other authentication mechanics etc. When connected to, or when logging into, the entertainment system, the user may provide an input or selection for the system to determine the user selected content, in one embodiment. The user input or selection may also be previously stored within the entertainment system or otherwise be saved and communicated to the entertainment system, according to an exemplary embodiment. The method 1700 may move to 1704, wherein a user input or selection from the user is received at the entertainment system 102. The method 1700 moves to 1706, wherein it is determined whether the user input or selection is the name of, or an identifier for, the title or name of the content. If it is determined at 1706 that the user input or selection is the title or the name of the content, the method 1700 moves to 1708, wherein content corresponding to the title is determined. If it is determined at 1706 that the user input or selection is not the title or the name of the content, the method 1700 moves to 1712, wherein it is checked whether the user input or selection is metadata of the content other than the title. If at 1712, it is determined that the input or the selection is of the metadata, then the content is selected based on the metadata at 1714. If at 1712, it is determined that the input or the selection is not metadata, then the method, according to an exemplary embodiment, may move back to 1704, wherein the entertainment system 102 waits for user input or selection. According to an exemplary embodiment, 1708 and 1714 may merge at 1710, where the content obtained from either branch (based on title or metadata) marked as user selected content, and the method 1700 may terminate, according to one embodiment. These decisions and/or actions may, e.g., but not limited to, be triggered, taken and/or performed, during the execution of a process in real time, on the fly, immediately, automatically, without noticeable delay, with negligible delay, and/or without interruption, etc., according to one exemplary embodiment.

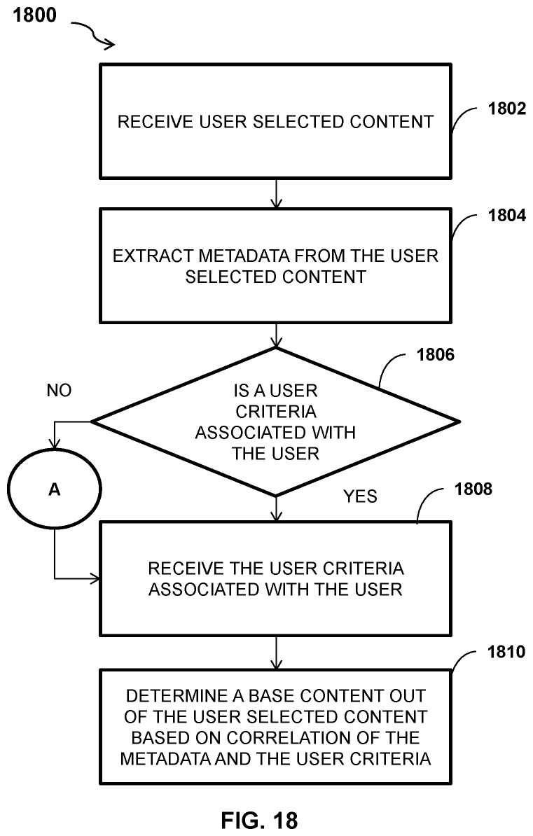

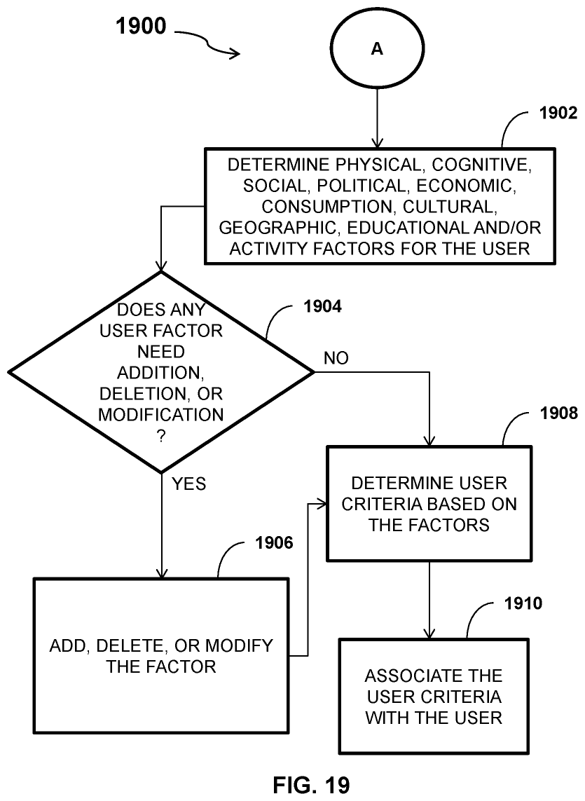

FIG. 18 illustrates via a flowchart, a method 1800, for determining base content, according to an embodiment of the present invention. The method 1800, according to an exemplary embodiment, may begin at 1802, where the user selected content is received at the entertainment system 102. The method 1800 may move to 1804, wherein metadata associated with the user selected content may be extracted by the entertainment system 102. The method 1800, according to an exemplary embodiment, moves to 1806, where it may be determined whether a user criteria is associated with the user. If it is determined at 1806 that a user criteria is associated with the user, the method 1800 may move to 1808, where the user criteria associated with the user may be received at the entertainment system 102. The method, according to an exemplary embodiment, may move to 1810, where a base content out of the user selected content is determined, based on correlation of the metadata and the user criteria, and method 1800 may terminate. If it may be determined at 1806 that a user criteria is not associated with the user, the method 1800 may move to step A (please see, method 1900, FIG. 19). After associating the user criteria with the user, in the method 1900, the method 1800 may move back to 1808 and may continue as described above. These decisions and/or actions may, e.g., but not limited to, be triggered, taken or performed, during the execution of a process in real time, on the fly, immediately, automatically, without noticeable delay, with negligible delay, and/or without interruption, according to one exemplary embodiment.

FIG. 19 illustrates via a flowchart, the method 1900, for associating the user criteria with the user, according to an embodiment of the present invention. The method 1900, according to an exemplary embodiment, may begin at 1902, where, e.g., but not limited to, physical, cognitive, social, political, economic, consumption, cultural, geographic, educational, and/or activity factors associated with the user are determined, etc. The method 1900, according to an exemplary embodiment, may move to 1904, where it may be determined whether any of the factors needs any updating, that is addition of a new factor, deletion of an existing factor or modification of an existing factor. If it is determined at 1904 that no updating of any factor is required, the method 1900 may move to 1908, where the user criteria may be determined based on the existing factors. The method 1900 may move to 1910, where the user criteria is associated with the user and the method 1900 may terminate. If it is determined at 1904 that updating of any factor is required, the method 1900 may move to 1906, where the user criteria is updated based on addition of a new factor, deletion or modification of an existing factor. The method 1900, according to an exemplary embodiment, may move to 1910, where the updated user criteria may be associated with the user and/or the method 1900 may terminate. These decisions and/or actions may, e.g., but not limited to, be triggered, taken or performed, during the execution of a process in real time, on the fly, immediately, automatically, without noticeable delay, with negligible delay, and/or without interruption, according to one exemplary embodiment.

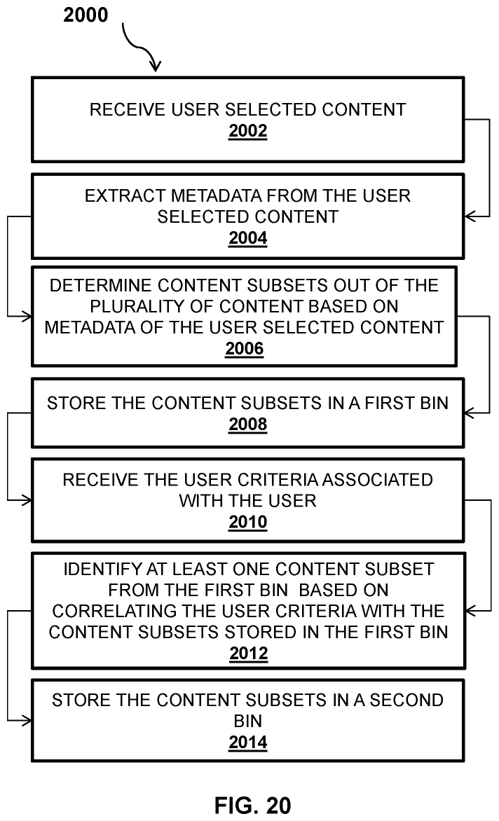

FIG. 20 illustrates via a flowchart, a method 2000, for storing content subsets in a second bin, according to an embodiment of the present invention. The method 2000, according to an exemplary embodiment, may begin at 2002, where user selected content is received by the entertainment system 102. The method 2000 may move to 2004, where metadata from the user selected content is extracted. The method 2000, according to an exemplary embodiment, may move to step 2006, where content subsets out of the plurality of content based on metadata of the user selected content is determined. The method 2000, according to an exemplary embodiment, may move to 2008, where the determined content subsets are stored in a first bin. The method 2000 may move to 2010, where, according to an exemplary embodiment, the user criteria 204 may be associated with the user is received by the entertainment system 102. The method 2000 may move to 2012, where at least one content subset from the first bin is identified based on correlating the user criteria with the content subsets stored in the first bin. The method 2000 may move to 2014, where the identified at least one content subset is stored in a second bin, and the method 2000 may terminate. These decisions and/or actions may, e.g., but not limited to, be triggered, taken or performed, during the execution of a process in real time, on the fly, immediately, automatically, without noticeable delay, with negligible delay, and/or without interruption, according to one exemplary embodiment.

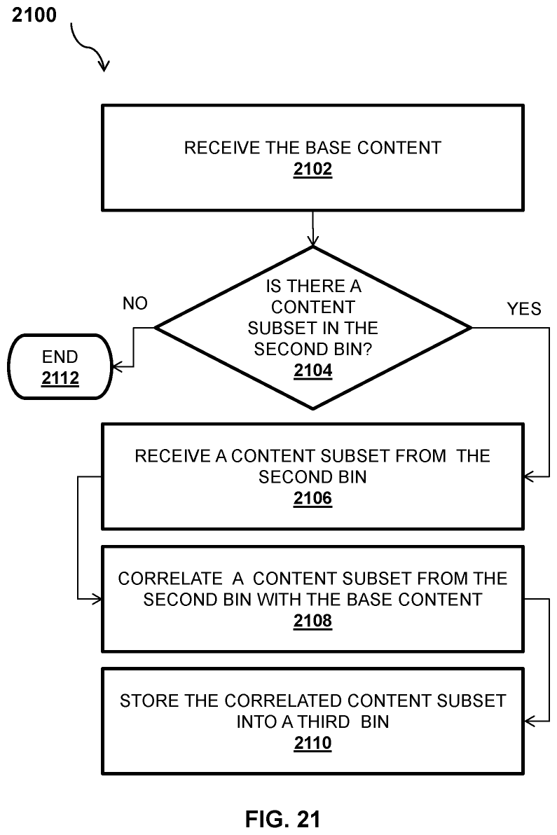

FIG. 21 illustrates via a flowchart, a method 2100, for storing content subsets in a third bin, according to an embodiment of the present invention. The method 2100 may begin at step 2102, where base content is received by the entertainment system 102. The method 2100 may move to 2104, where it may be determined whether there may be any content subset present in the second bin for processing, according to an exemplary embodiment. If it is determined at 2104 that a content subset is present in the second bin for processing, the method 2100, according to an exemplary embodiment, may move to 2106, where the content subset present in the second bin may be received by the entertainment system 102. The method 2100 may move to 2108, where the content subset from the second bin is correlated with the base content. The method 2100 may move to step 2110, where the correlated content subset may be stored in a third bin, and the method 2100 may terminate, according to an exemplary embodiment. If it is determined at 2104 that no content subset may be present in the second bin for processing, the method 2100 may end at 2112, according to an exemplary embodiment.

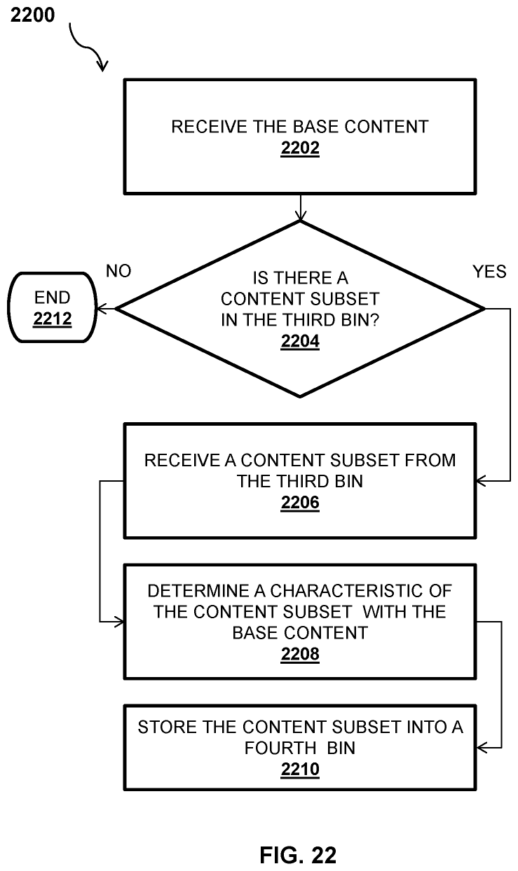

FIG. 22 illustrates via a flowchart, a method 2200, for storing content subsets in a fourth bin, according to an embodiment of the present invention. The method 2200, according to an exemplary embodiment, may begin at 2202, where base content is received by the entertainment system 102. The method 2200 may move to 2204, where it may be determined whether any content subset is present in the third bin for processing. If it is determined at 2204 that a content subset is present in the third bin for processing, the method 2200 may move to 2206, where the content subset present in the third bin may be received by the entertainment system 102. The method 2200, according to an exemplary embodiment, may move to 2208, where a characteristic of the content subset with the base content is determined. The method 2200 may move to 2210, where the content subset is stored in a fourth bin, and the method 2200 may terminate. If it is determined at 2204 that no content subset is present in the third bin for processing, the method 2200 may end at 2212, according to an exemplary embodiment.

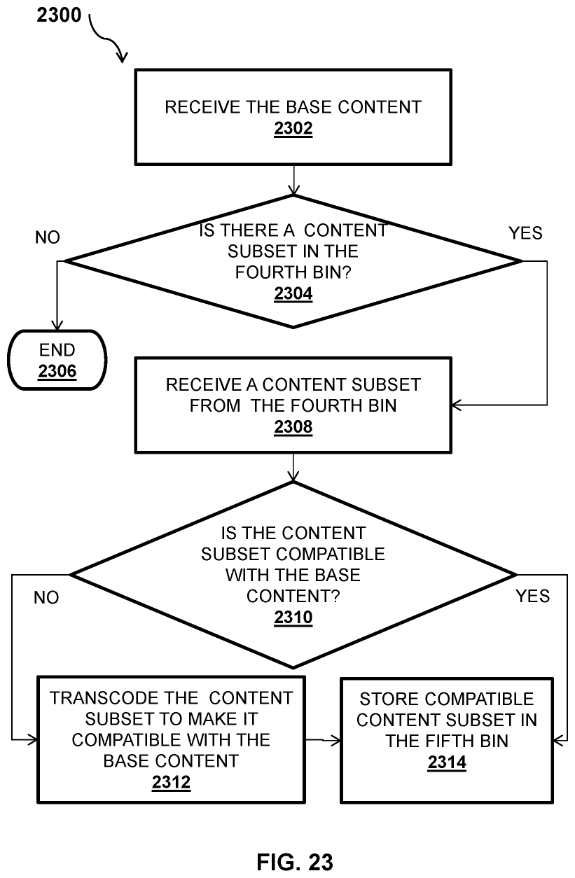

FIG. 23 illustrates via a flowchart, a method 2300, for storing compatible content subsets in a fifth bin, according to an embodiment of the present invention. The method 2300 may begin at 2302, where base content may be received by the entertainment system 102, according to an exemplary embodiment. The method 2300, according to an exemplary embodiment, may move to 2304, where it may be determined whether any content subset is present in the fourth bin for processing, according to an exemplary embodiment. If it is determined at 2304 that no content subset is present in the fourth bin for processing, the method 2300 may end at 2306. If it is determined at 2304 that a content subset is present in the fourth bin for processing, the method 2300 may move to 2308, where the content subset present in the fourth bin may be received by the entertainment system 102, according to an exemplary embodiment. The method 2300 may move to 2310, where it may be determined whether the content subset is compatible with the base content, according to an exemplary embodiment. If it is determined at 2310, according to an exemplary embodiment, that the content subset is compatible with the base content, the method 2300 may move to 2314 where the content subset is stored in a fifth bin, and the method 2300 may terminate. If it is determined at 2310, according to an exemplary embodiment, that the content subset is incompatible with the base content, the method 2300 may move to 2312 where the content subset may be transcoded to make it compatible with the base content. The method 2300 may move to 2314 where the content subset may be stored in a fifth bin, and the method 2300 may terminate.

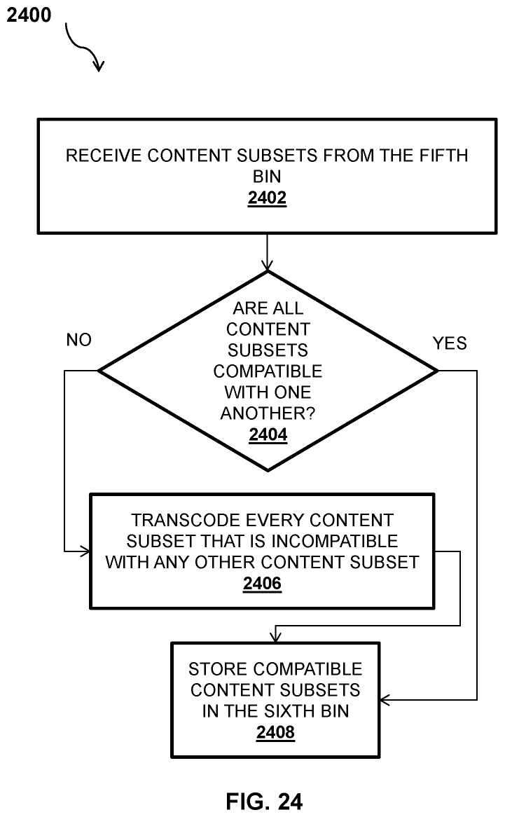

FIG. 24 illustrates via a flowchart, a method 2400, for making content subsets compatible with one another, according to an embodiment of the present invention. The method 2400, according to an exemplary embodiment, may begin at 2402, where content subsets from the fifth bin may be received by the entertainment system 102. The method 2400, according to an exemplary embodiment, may move to 2404, where it may be determined whether all content subset present in the fifth bin are compatible with one another, according to an exemplary embodiment. If it is determined at 2404, according to an exemplary embodiment, that all content subset present in the fifth bin are compatible with one another, the method 2400 may move to 2408, where all content subsets may be stored in a sixth bin and the method 2400 may terminate. If it is determined at 2404 that all content subset present in the fifth bin may not be compatible with one another, the method 2400, according to an exemplary embodiment, may move to 2406, where content subsets may be transcoded to make them compatible with one another. The method 2400 may move to 2408, where all content subsets may be stored in a sixth bin, and the method 2400 may terminate.

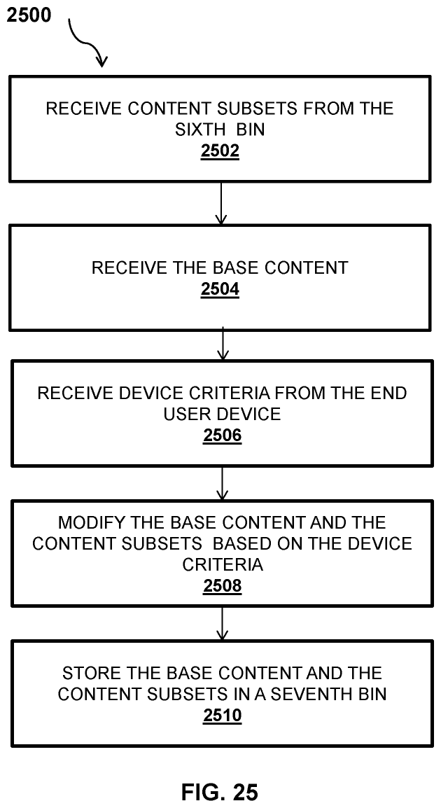

FIG. 25 illustrates via a flowchart, a method 2500, for modifying the content subsets and the base content compatible with the end user device, according to an embodiment of the present invention. The method 2500 may begin at 2502, where content subsets from the sixth bin may be received by the entertainment system 102. The method 2500, according to an exemplary embodiment, may move to 2504, where the base content may be received by the entertainment system 102. The method 2500, according to an exemplary embodiment, may move to 2506, where the device criteria 204 may be received by the entertainment system 102 from the end user device 104. The method 2500, according to an exemplary embodiment, may move to 2508, where the base content and the content subsets are modified by the entertainment system 102, based on the device criteria 204, so that they are compatible with the end user device 104. The method 2500, according to an exemplary embodiment, may move to 2510, where the base content and the content subsets may be stored in a seventh bin, and the method 2500 may terminate.

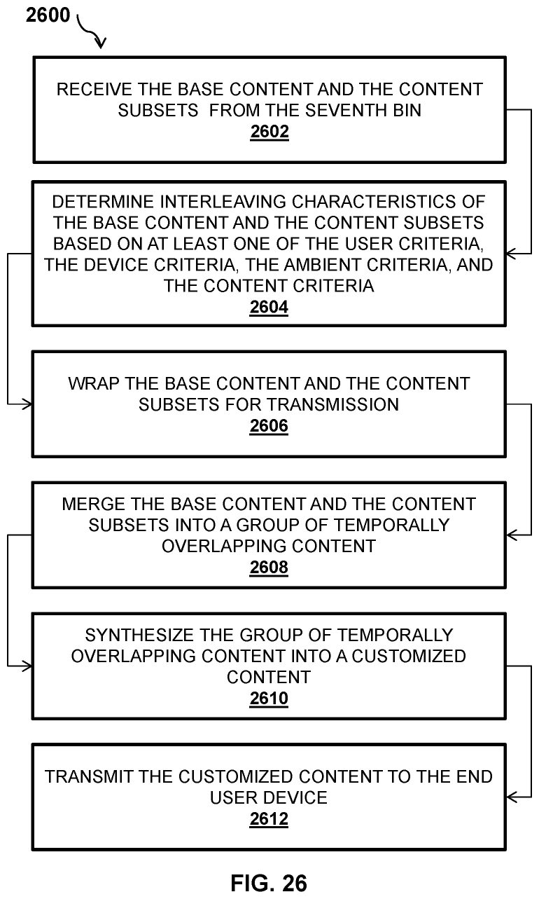

FIG. 26 illustrates via a flowchart, a method 2600, for generating customized content based on the modified base content and the content subsets, according to an embodiment of the present invention. The method 2600, according to an exemplary embodiment, may begin at 2602, where the base content and the content subsets from the seventh bin may be received by the entertainment system 102. The method 2600, according to an exemplary embodiment, may move to 2602 where interleaving characteristics of the base content and the content subsets may be determined based on at least one or more of: the user criteria, the device criteria, the ambient criteria, and/or the content criteria, etc. The method 2600, according to an exemplary embodiment, may move to 2604, where the wrapping module may wrap the base content and/or the content subsets for transmission to the end user device 104. The method 2600 may move to step 2606, where the merging module may merge the base content and/or the content subsets into a group of temporally overlapping content, etc. The method 2600, according to an exemplary embodiment, may move to 2608, where the synthesizing module synthesizes the group of temporally overlapping content into customized content. The method 2600 may move to 2610, where the transmission module may transmit the customized content to the end user device 104, according to an exemplary embodiment. The generation of the customized content may, e.g., but not limited to, be done in real time, on the fly, immediately, automatically, without noticeable delay by the user, with negligible delay, without user noticeable delay, without interruption during presentation, in the absence of user interruption, or dynamically with immediate sub-second response time, according to one exemplary embodiment. Further, the generation and/or presentation of the customized content may include, e.g., but is not limited to, decisions made, or actions triggered, taken or performed, during the execution of a process without any implicit and/or explicit user input or intervention, according to one exemplary embodiment.

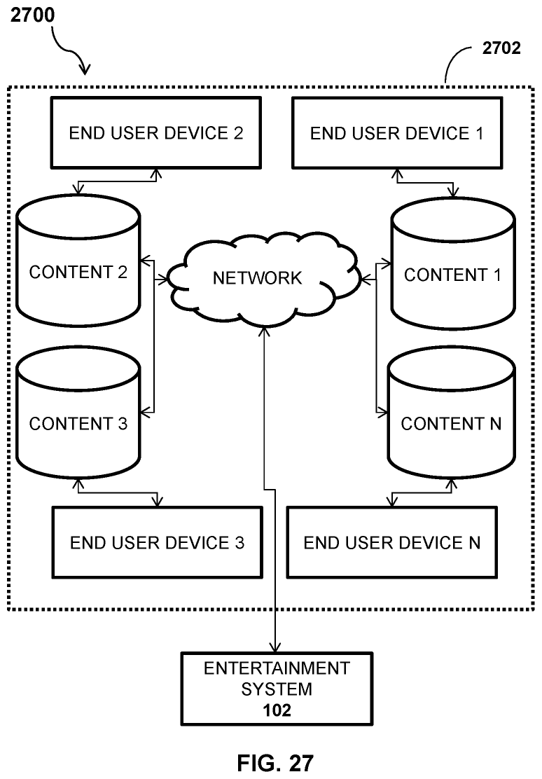

FIG. 27 is high level block diagram of a network environment 2700 including an entertainment system 102, according to an embodiment of the present invention. The system 102, according to an exemplary embodiment, may be communicatively coupled to content delivery network 2702. In this embodiment, the entertainment system 102, according to an exemplary embodiment, may retrieve content from the content 1 through content 4, may apply various criteria to the content to generate customized content. The customized content, according to an exemplary embodiment, may be provided to the end user devices 1-N via the content delivery network CDN 2702 for consumption by a user. The CDN 2702 may enable reliable and fast delivery of the customized content to the end user devices 1-N, according to an exemplary embodiment.

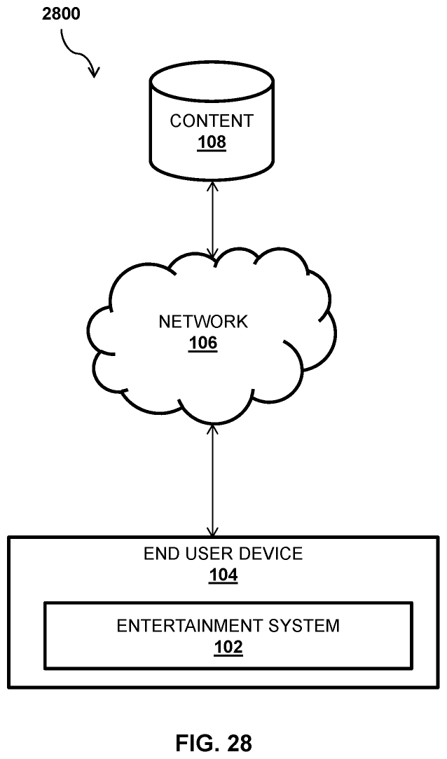

FIG. 28 is high level block diagram of a network environment 2800 including an entertainment system 102, according to an embodiment of the present invention. The system 102, according to an exemplary embodiment, may be communicatively coupled to content 108 via the network 106. In this embodiment, the entertainment system 102, according to an exemplary embodiment, may reside on the entertainment device 102. The content 108 may be retrieved by the entertainment system to the end user device 104. The customized content may be generated at the end user device 104 based on the content 108 and various criteria as described above, according to an exemplary embodiment. The customized content, according to an exemplary embodiment, may be played on the end user device 104. The generation and/or presentation of the customized content may, e.g., but not limited to, be done in real time, on the fly, immediately, automatically, without noticeable delay by the user, with negligible delay, without user noticeable delay, without interruption during presentation, in the absence of user interruption, or dynamically with immediate sub-second response time, according to one exemplary embodiment. Further, the generation and/or presentation of the customized content may include, but is not limited to, decisions made, or actions triggered, taken or performed, during the execution of a process without any implicit and/or explicit user input or intervention, according to one exemplary embodiment.

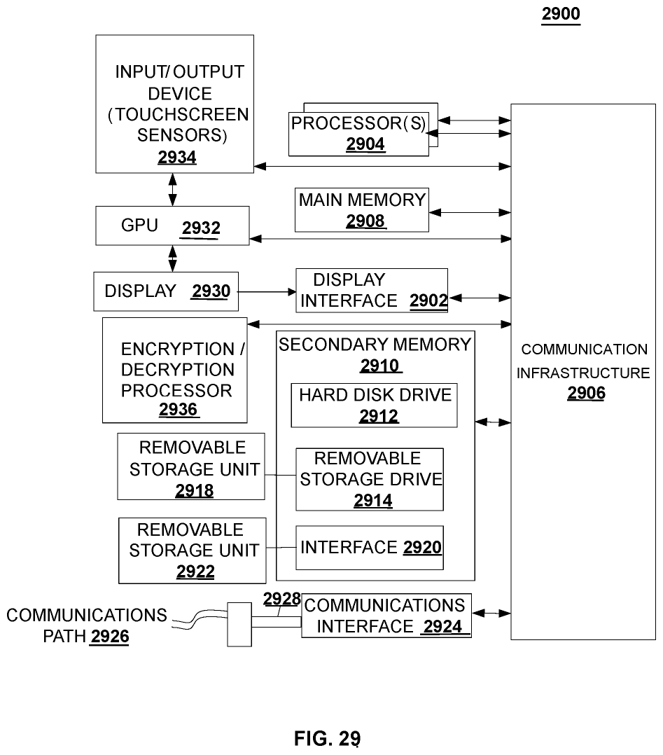

FIG. 29 depicts an example high level block diagram 2900 illustrating an example computer system as may be used in various example components of computer devices and systems, according to an exemplary embodiment of the present invention.

Specifically, FIG. 29 depicts a schematic illustration of an example communications and/or computing system 2900 implemented according to an exemplary embodiment. The system 2900 can include at least one processing element 2910, for example, a central processing unit (CPU). According to an exemplary embodiment, the CPU is coupled via a bus 2905 to a memory 2920. The memory 2920 includes, in an exemplary embodiment, a memory portion 2922 that can contain instructions that when executed by the processing element 2910 can perform the methods described in more detail herein. The memory 2920 may be further used, according to an exemplary embodiment, as a temporary storage element for the processing element 2910, and/or other uses, as the case may be. The memory may comprise, in an exemplary embodiment, volatile memory such as, e.g., but not limited to, a random access memory (RAM), and/or a non-volatile memory (NVM), such as, e.g., but not limited to, Flash memory, etc., according to an exemplary embodiment. Memory 2920 may further include, in an exemplary embodiment, a memory portion 2924 containing an application program and/or application data, etc., according to an exemplary embodiment. The processing element 2910 may be coupled to an input 2950, in one exemplary embodiment. The processing element 2910 may be further coupled with a database 2930 and/or other storage device 2930, according to an exemplary embodiment. Database system and/or storage device 2930, in an example embodiment, can be used for the purpose of holding a copy of the method executed in accordance with the disclosed technique, according to an exemplary embodiment. Database 2930 may further include, e.g., but may not be limited to, a storage portion 2934, which may include and/or contain sub-portions of an application, and/or data referenced by the application, in an exemplary embodiment. In one embodiment, the promotion system can be configured to execute the methods described herein with respect of the remaining figures, according to an exemplary embodiment. The exemplary method, system, and/or computer program products, may be hardwired or, presented as a series of programmable instructions to be executed by the processing element 2910.

The principles disclosed herein can be implemented as hardware, firmware, software or any combination thereof. Moreover, the software can be implemented as an application program tangibly embodied on a program storage unit or computer readable medium. The application program may be uploaded to, and/or be executed by, a machine comprising any suitable architecture, according to an exemplary embodiment. The machine may be implemented on a computer platform 2900 having hardware such as, e.g., but not limited to, a processing unit (“CPU”) 2910, a memory 2920, and/or input interfaces 2950, output interfaces (not shown), as well as other components not shown for simplicity, but as would be well known to those skilled in the relevant art, according to an exemplary embodiment. The computer platform may also include, in an exemplary embodiment, an operating system and/or microinstruction code. The various processes and/or functions described herein may be either part of the microinstruction code and/or part of the application program, and/or any combination thereof, which may be executed by a CPU 2910, whether or not such computer and/or processor is explicitly shown, according to an exemplary embodiment. In addition, various other peripheral units may be connected, and/or coupled, to the computer platform such as, e.g., but not limited to, an additional memory unit 2926 and/or removable memory unit 2926, an additional data storage unit 2936 and/or removable storage unit 2936, and a printing unit, and/or display unit, and/or other input 2950, output 2960, communication 2970 and/or networking components 2970, etc., according to an exemplary embodiment.

References to “one embodiment,” “an embodiment,” “example embodiment,” “various embodiments,” “exemplary embodiment,” “exemplary embodiments,” etc., may indicate that the embodiment(s) so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used, according to an exemplary embodiment. It should be understood that these terms are not intended as synonyms for each other. Rather, in particular embodiments, “connected” may be used to indicate that two or more elements are in direct or indirect physical or electrical contact with each other, according to an exemplary embodiment. “Coupled” may mean that two or more elements are in direct physical or electrical contact, according to an exemplary embodiment. However, “coupled” may also mean that two or more elements are not in direct contact with each other, but yet still co-operate or interact with each other, according to an exemplary embodiment.

An algorithm is here, and generally, considered to be a self-consistent sequence of acts or operations leading to a desired result, according to an exemplary embodiment. These include physical manipulations of physical quantities. Usually, though not necessarily, these quantities take the form of electrical or magnetic signals capable of being stored, transferred, combined, compared, and otherwise manipulated, according to an exemplary embodiment. It has proven convenient at times, principally for reasons of common usage, to refer to these nontransitory signals as bits, values, elements, symbols, characters, terms, numbers or the like, according to an exemplary embodiment. It should be understood, however, that all of these and similar terms are to be associated with the appropriate physical quantities and are merely convenient labels applied to these quantities, according to an exemplary embodiment.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices, according to an exemplary embodiment.

In a similar manner, the term “processor” can refer to any device or portion of a device that processes electronic data from registers and/or memory to transform that electronic data into other electronic data that can be stored in registers and/or memory, according to an exemplary embodiment. A “computing platform” can comprise one or more processors, according to an exemplary embodiment. In one embodiment, a processor can include an embedded processor, and/or another subsystem processor, and/or a system on a chip (SOC), device, according to an exemplary embodiment.

Embodiments may include apparatuses for performing the operations herein, according to an exemplary embodiment. An apparatus may be specially constructed for the desired purposes, or it may comprise a general purpose and/or special purpose device selectively activated or reconfigured by a program stored in the device, according to an exemplary embodiment.

Computer programs (also called computer control logic), may include computer application programs, and can include object-oriented computer programs, and can be stored in memory 2920, and/or secondary memory, such as, e.g., storage 2920, 2922, 2924, 2926, 2930, 2934, 2936 and/or removable memory and/or storage units 2926, 2936, also called computer program products, according to an exemplary embodiment. Such computer programs, when executed, may enable the computer system 2900 to perform the features as discussed herein. In particular, the computer programs, when executed, may enable the processor 2910 to provide various functionality to the system 2900 so as perform certain functions, according to an exemplary embodiment. Accordingly, such computer programs may represent controllers of the computer system 2900, according to an exemplary embodiment.

In another exemplary embodiment, the methods may be directed to a computer program product comprising a computer readable medium having control logic (computer software) stored therein. The control logic, when executed by the processor 2910, may cause the processor 2910 to perform features as described herein, according to an exemplary embodiment. In another exemplary embodiment which can be implemented using software, the software can be stored in a computer program product 2936, 2926, and can be loaded into computer system 2900 using, e.g., but not limited to, the storage 2930, the removable memory and/or storage device 2926, 2936, respectively, hard drive and/or communications and/or network interface 2970, and/or router, etc. The control logic (software), when executed by the processor 2910, can cause the processor 2910 to perform the functions as described herein, according to an exemplary embodiment. The computer software can run as a standalone software application program running atop an operating system (OS), or may be integrated into the operating system and/or application program, and/or may be executed as an applet, or networked and/or client-server, and/or browser-based and/or other process as is well known, according to an exemplary embodiment.

In yet another embodiment, implementation may be primarily in hardware using, for example, but not limited to, hardware components such as, e.g., but not limited to, application specific integrated circuits (ASICs), or one or more state machines, etc., according to an exemplary embodiment. Implementation of the hardware state machine so as to perform the functions described herein will be apparent to persons skilled in the relevant art(s), according to an exemplary embodiment.

In another exemplary embodiment, as noted, implementation can be primarily in firmware.

In yet another exemplary embodiment, implementation can combine any of, e.g., but not limited to, hardware, firmware, and software, etc.

Exemplary embodiments may also be implemented as instructions stored on a machine-readable medium, which may be read and executed by a computing platform to perform the methods described herein. A machine-readable medium may include any mechanism for storing or transmitting information in a form readable by a machine (e.g., a computer). For example, a machine-readable medium can include read only memory (ROM); random access memory (RAM); magnetic disk storage media; optical storage media; flash memory devices; electrical, optical, acoustical or other form of nontransitory propagated signals (e.g., carrier waves, infrared signals, digital signals, etc.), memory 2920, storage 2930, and others, according to an exemplary embodiment.

The exemplary embodiments make reference to wired, and/or wireless networks, according to an exemplary embodiment. Wired networks can include any of a wide variety of well known means for coupling voice and data communications devices together, according to an exemplary embodiment. Similarly, any of various exemplary wireless network technologies may be used to implement the embodiments discussed, according to an exemplary embodiment. Specific details of wireless and/or wired communications networks are well known and are not included, as will be apparent to those of ordinary skill in the relevant art, according to an exemplary embodiment.

All examples and conditional language recited herein are intended for pedagogical purposes to aid the reader in understanding the principles of the invention and the concepts contributed by the inventor to furthering the art, and are to be construed as being without limitation to such specifically recited examples and conditions, according to exemplary embodiments. Moreover, all statements herein reciting principles, aspects, and embodiments of the invention, as well as specific examples thereof, are intended to encompass both structural and functional equivalents thereof, according to an exemplary embodiment. Additionally, it is intended that such equivalents include both currently known equivalents as well as equivalents developed in the future, i.e., any elements developed that perform the same function, regardless of structure, according to an exemplary embodiment.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer, according to an exemplary embodiment. For clarity, only those aspects of the system germane to the invention are described, and product details well known in the art are omitted. For the same reason, the computer hardware is not described in further detail. It should thus be understood that the invention is not limited to any specific computer language, program, communications and/or computing device, and/or computer, etc. It is further contemplated that the present invention may be run on a stand-alone computer system, according to an exemplary embodiment, and/or may be run from a server computer system that can be accessed by a plurality of client computer systems interconnected over a network, according to an exemplary embodiment, such as, e.g., but not limited to, an intranet network, internet network, etc., and/or that is accessible to clients over the global Internet, etc. . . . In addition, many exemplary embodiments of the present invention may have application to a wide range of industries, according to an exemplary embodiment. To the extent the present application discloses a system, the method implemented on a system, as well as a computer program product, such as, e.g., but not limited to, software instructions stored on a computer-readable/accessible nontransitory storage medium and executed on an electronic computer processor as a computer program to perform various steps of the method on a special purpose computer and/or in communication with other communication network devices including distributed mobile devices over one or more communication networks which may include wireless communication networks, etc., are within the scope of the present invention, according to an exemplary embodiment. Further, to the extent the present application discloses a method, a system of apparatuses configured to implement the method are within the scope of the present invention, according to an exemplary embodiment.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the following claims, and the full scope of equivalents thereof.

What is claimed is:

1. A method of generating and presenting customized movie content, the method comprising:
receiving, by at least one electronic computer processor, an electronic request associated with movie content to be presented from an entertainment system;
electronically storing, by the at least one electronic computer processor, a plurality of movie content;
electronically tagging, by the at least one electronic computer processor, at least a portion of said plurality of movie content with at least one or more of:
stored information, or
real-time information;
first electronically determining, by the at least one electronic computer processor, a base movie content from the plurality of movie content, based at least in part on at least one user criteria of at least one or more of:
at least one end user,
at least one end user device, or
at least one entertainment system,
wherein the at least one user criteria is based on at least one user information;
electronically accessing, by the at least one electronic computer processor, at least one metadata associated with the base movie content;
electronically analyzing at least one capability of at least one or more of:
the at least one end user device,
the at least one end user,
the at least one entertainment system, or
at least one end user environment;
second electronically determining, by the at least one electronic computer processor, at least one movie content subset based on at least one or more of:
the at least one user criteria, or
the least one metadata associated with the base movie content;
electronically selecting, by the at least one electronic computer processor, without requesting an acceptance confirmation from the end user, at least one selected of said at least one movie content subset, based on at least one or more of:
the at least one user criteria,
the at least one or more entertainment system criteria,
the at least one metadata associated with the base movie content,
the at least one capability of the at least one end user device,
the at least one interest of the at least one end user,
the at least one capability of the at least one entertainment system, or
the at least one capability of the at least one end user environment;
wherein the electronically selecting the least one stored user information is obtained and analyzed, at least in part, using at least one artificial intelligence technique or at least one machine learning technique;
electronically processing, by the at least one electronic computer processor, of the base movie content and the at least one selected of said at least one movie content subset,
wherein the electronic processing of the base movie content and the at least one selected of said at least one movie content subset comprises:
third electronically determining, by the at least one electronic computer processor, at least one insertion location associated with the base movie content for the at least one selected of said at least one movie content subset to be at least one or more of inserted, combined, merged or linked with the base movie content;
wherein the electronically processing of the base movie content and the at least one selected of said at least one movie content subset is derived, at least in part, using at least one artificial intelligence technique,
electronically generating, by the at least one electronic computer processor, a customized movie content comprising the base movie content and the at least one selected of said at least one movie content subset for the at least one end user device;
electronically evaluating one or more conditions related to network communications, bandwidth, or network security; and
electronically transmitting, by the at least one electronic computer processor, said customized movie content to the at least one end user device.

2. The method of claim 1, wherein the first electronically determining the base movie content comprises:
electronically storing, by the at least one electronic computer processor, the at least one user criteria in an electronic database, wherein the at least one user criteria comprises at least one or more of:
at least one physical factor of the user,
at least one cognitive factor,
at least one social factor,
at least one political factor,
at least one cultural factor,
at least one economic factor, or
at least one consumption factor;
electronically storing, by the at least one electronic computer processor, at least one or more of: user entered information, publicly available information associated with the at least one end user, or information entered using a human machine interface method;
electronically storing, by the at least one electronic computer processor, a plurality of movie content in an electronic database, wherein the plurality of movie content comprises at least one or more of:
at least one audio,
at least one animation,
at least one graphic,
at least one three dimensional visual,
at least one video, or
at least one language translation subtitle;
electronically accessing, by the at least one electronic computer processor, user selected movie content from said plurality of movie content based at least in part on receiving an input from the at least one end user, wherein said input comprises at least one or more of:
a name of a book,
a name of a movie,
a name of a person,
a name of an actor,
a name of a character,
a name of historical event, or
a cultural factor;
electronically accessing, by the at least one electronic computer processor, at least one metadata associated with the user selected movie content; and
electronically analyzing, by the at least one electronic computer processor, the at least one user criteria with the user selected movie content to fourth electronically determine the base content from the plurality of content.

3. The method of claim 1, wherein the second electronically determining the at least one selected of said at least one movie content subset comprises:
analyzing, by the at least one electronic computer processor, the at least one metadata associated with the base movie content;
analyzing, by the at least one electronic computer processor, at least one metadata associated with the at least one of said at least one movie content subset;
analyzing, by the at least one electronic computer processor, the compatibility of the base movie content with the at least one of said at least one movie content subset;
identifying, by the at least one electronic computer processor, at least one of said at least one movie content subset based on a correlation between the user criteria and the at least one of said least one movie content subset; and
analyzing, by the at least one electronic computer processor, the at least one user criteria with the at least one of said at least one movie content subset to determine the at least one selected of said at least one movie content subset.

4. The method of claim 3, wherein the electronic processing of the base movie content and the at least one selected of said at least one movie content subset comprises:
electronically correlating, by the at least one electronic computer processor, each of the at least one selected of said at least one movie content subset with the base movie content;
fourth electronically determining, by the at least one electronic computer processor, a characteristic of each of the at least one selected of said at least one movie content subset with a characteristic of the base movie content and a characteristic of each of the at least one movie content subset with a characteristic of the others of the at least one selected of said at least one movie content subset based on at least one or more of:
a data signature,
fingerprint code,
a timestamp, or
the metadata of the base movie content; and
electronically transcoding, by the at least one electronic computer processor, the at least one selected of said at least one movie content subset for compatibility with the base movie content.

5. The method of claim 3, wherein the identifying at least one of said at least one movie content subset based on a correlation between the user criteria and the at least one of said least one movie content subset comprises:
determining one or more movie content metadata parameters of a particular movie content subset;
determining one or more user criteria parameters of at least one end user;
evaluating one or more pre-identification movie content metadata parameters and one or more user criteria parameters before the particular movie content subset is identified;
providing, as input to an algorithm derived at least in part from an artificial intelligence agent, the one or more pre-identification user criteria parameters and the one or more pre-identification movie content metadata parameters;
determining, as output from the algorithm, at least one particular movie content subset; and
then identifying the at least one particular movie content subset correlating to the user criteria.

6. The method of claim 4, wherein the electronically generating the customized movie content comprises:
electronically receiving, by the at least one electronic computer processor, the at least one capability of the at least one end user device comprising device criteria, wherein the device criteria include at least one of: type of device, software capabilities, hardware capabilities, audio capabilities, video capabilities, processing capabilities, or communication capabilities;
electronically processing, by the at least one electronic computer processor, the base movie content and the at least one selected of said at least one movie content subset based on the device criteria;
fifth electronically determining, by the at least one electronic computer processor, interleaving characteristics of the base movie content and the at least one selected of said at least one movie content subset based on at least one or more of: the user criteria, the device criteria, the ambient criteria, the environment criteria, or the content criteria;
electronically wrapping, by the at least one electronic computer processor, the base movie content and the one or more selected movie content subsets;
electronically merging, by the at least one electronic computer processor, the base movie content and the one or more selected movie content subsets into a group of temporally overlapping movie content; and
electronically synthesizing, by the at least one electronic computer processor, the group of temporally overlapping movie content into the customized movie content for transmission to the at least one end user device

7. The method of claim 6, wherein the electronically determining interleaving characteristics of the base movie content and the at least one selected movie content subsets, comprises:
determining one or more pre-interleaved base movie content metadata parameter;
determining one or more pre-interleaved movie content subset metadata parameter;
determining one or more user criteria, device criteria, environment criteria, or content criteria parameter;
evaluating one or more pre-interleaved base movie content metadata parameter, one or more pre-interleaved movie content subset metadata parameter and one or more user criteria, device criteria, environment criteria, or content criteria parameter before the particular base content and at least one movie content subset are interleaved;
providing, as input to an algorithm derived at least in part from an artificial intelligence agent, the one or more pre-interleaved base movie content metadata parameter, the pre-interleaved movie content subset metadata parameter and the one or more user criteria, device criteria, environment criteria, or content criteria parameter;
determining, as output from the algorithm, at least one particular base movie content metadata parameter and at least one particular movie content subset metadata parameter; and
identifying the at least one particular base movie content and at least one particular movie content subset taking into consideration one or more user criteria, device criteria, environment criteria, or content criteria parameter.

8. The method of claim 1, wherein the first electronically determining the base movie content comprises fourth electronically determining, by the at least one electronic computer processor, the user criteria based on the at least one stored user information,
wherein the at least one stored user information is analyzed and obtained in real-time using at least one artificial intelligence technique, and
wherein the at least one stored user information is determined from merging and weighting of user criteria associated with two or more end users.

9. The method of claim 2, wherein the human machine interface method comprises providing, by the at least one electronic computer processor, an input to the at least one end user device based on at least one or more of: a gesture from the at least one end user, a facial expression of the at least one end user, a brain activity of the at least one end user, an eye movement of the at least one end user, an audio sound generated by the at least one end user, or a biometric information of the at least one end user.

10. The method of claim 1, wherein the electronically storing of the plurality of movie content and the electronically tagging of the plurality of movie content with stored, predetermined, or real-time information, wherein the information further comprises:
information about at least one or more of:
a timestamp,
a start scene,
a stop scene,
a beginning scene,
an end scene,
a person,
an actor,
an author,
an artist,
a singer,
a director,
a family member
a friend,
a content resolution,
a length,
a language, or
a cultural factor.

11. The method of claim 1, wherein the electronically processing comprises wherein the third electronically determining, by the at least one electronic computer processor, the at least one insertion location of the base movie content, wherein the at least one insertion location comprises at least one compatible insertion location:
wherein the at least one compatible insertion location comprises at least one or more of:
at the beginning of,
within, or
at the end of,
the base movie content, for each of the one or more selected movie content subset to be inserted into the base movie content to generate the customized movie content.

12. The method of claim 11, wherein the determining of a compatible insertion location comprises:
determining one or more pre-insertion base movie content metadata;
determining one or more pre-insertion movie content subset metadata;
determining one or more user criteria, device criteria, ambient criteria, environment criteria, or content criteria;
evaluating one or more pre-insertion base movie content metadata, one or more pre-insertion movie content subset metadata and one or more user criteria, device criteria, ambient criteria, environment criteria, or content criteria before the at least one compatible insertion location is identified;
providing, as input to an algorithm derived at least in part from a machine learning technique, the one or more pre-insertion base movie content metadata, the pre-insertion movie content subset metadata and the one or more user criteria, device criteria, ambient criteria, environment criteria, or content criteria;
determining, as output from the algorithm, at least one particular base movie content metadata and at least one particular movie content subset metadata; and
identifying the at least one compatible insertion location for the at least one particular base movie content or the at least one particular movie content subset taking into consideration one or more of: content criteria, user criteria, ambient criteria, environment criteria, or device criteria.

13. The method of claim 12, wherein the machine learning technique comprises at least one or more of: linear regression, logistic regression, decision tree, support vector machine (SVM), naïve bayes, k-nearest neighbors (kNN), k-means clustering, random forest, dimensionality reduction, or gradient boosting algorithm.

14. The method of claim 1, wherein the electronically processing comprises electronically inserting, by the at least one electronic computer processor, at least one selected of said at least one movie content subset into the base movie content based on a score for each of said at least one movie content subset, wherein the score is fourth electronically determined, by the at least one electronic computer processor, based on at least one weighted summation of a plurality of the at least one user criteria of at least two or more of the at least one end user.

15. The method of claim 1, wherein the electronically processing the base movie content and the at least one selected of the at least one movie content subset comprises:
evaluating, as input to an algorithm derived at least in part from an artificial intelligence agent, at least one or more of: audio, video or text information;
determining, as output from the algorithm, a language translation for at least one or more of: audio, video or text information; and
identifying a compatible format for the language translation correlating to the base movie content and the at least one selected movie content subset.

16. A computing system configured to generate and transmit customized movie content, the computing system comprising:
at least one memory device configured to electronically store instructions, wherein the at least one memory device having electronically stored thereon at least one user criteria and a plurality of movie content, wherein the plurality of movie content comprises at least one or more of:
at least one text content,
at least one image content,
at least one audio content,
at least one video content,
at least one animation content,
at least one game content,
at least one augmented reality simulation content,
at least one virtual reality simulation content,
at least one graphic content,
at least one hologram content,
at least one language translation content,
at least one three dimensional visual content, or
at least one electronic computer processor communicatively coupled to the at least one memory device and configured to execute the instructions to cause the computing system to perform operations comprising to:
electronically tag at least a portion of the plurality of movie content with at least one or more of:
stored information, or
real-time information;
first electronically determine a base movie content from the plurality of movie content, based at least in part on the at least one user criteria,
wherein the at least one user criteria is based on at least one user information;
electronically access at least one metadata associated with the base movie content;
electronically analyze at least one capability of at least one or more of:
at least one end user device,
the at least one end user, or
at least one end user environment;
second electronically determine at least one movie content subset based on at least one or more of:
at least one user criteria,
at least one capability of the at least one end user device,
at least one interest of the at least one end user,
at least one cultural factor,
at least one capability of the at least one end user environment, or
the at least one metadata associated with the base movie content;
electronically select at least one selected of the at least one movie content subset, without requesting an acceptance confirmation from the end user, based on at least one or more of:
the at least one user criteria,
the at least one metadata associated with the base movie content,
the at least one capability of the at least one end user device,
the at least one cultural factor,
the at least one interest of the at least one end user, or
the at least one capability of the at least one end user environment; and
wherein the electronically select at least one selected of the at least one movie content subset is obtained and analyzed, at least in part, using at least one artificial intelligence technique or machine learning technique;
electronically process the base movie content and the at least one selected of the at least one movie content subset comprising:
third electronically determine at least one insertion location associated with the base movie content for the at least one selected of said at least one movie content subset to be inserted into the base movie content; and
wherein the electronically process of the base movie content and the at least one selected of said at least one movie content subset is derived, at least in part, using at least one artificial intelligence technique or machine learning technique;
electronically generate a customized movie content comprising the base movie content and the at least one selected of the at least one movie content subset for at least one end user device;
electronically evaluate one or more conditions relating to a network communication, a network bandwidth, or a network security; and
electronically transmit said customized movie content to the at least one end user device.

17. The system of claim 16, wherein the electronically process the base movie content and the at least one selected of the at least one movie content subset comprises:
evaluate, as input to an algorithm derived at least in part from an artificial intelligence agent, at least one or more of: audio, video, or text information;
determine, as output from the algorithm, a language translation for at least one or more of: the audio, video or text information; and
identify a compatible format for the language translation correlating to the base movie content and the at least one selected movie content subset.

18. The system of claim 17, wherein the language translation for the audio, video or text information includes two or more cultural factors.

19. The system of claim 16, wherein the system comprises at least one artificial intelligence software agent instruction, wherein the at least one artificial intelligence software agent instruction is configured:
determine one or more pre-insertion base movie content metadata parameters;
determine one or more pre-insertion movie content subset metadata parameters;
determine one or more user criteria, device criteria, ambient criteria, cultural factors, or content criteria parameters;
evaluate one or more pre-insertion base movie content metadata parameters, one or more pre-insertion movie content subset metadata parameters and one or more user criteria, device criteria, ambient criteria, cultural factors, or content criteria parameters before the at least one compatible insertion location is identified;
provide, as input to an algorithm derived at least in part from an artificial intelligence agent, the one or more pre-insertion base movie content metadata parameters, the pre-insertion movie content subset metadata parameters and the one or more user criteria, device criteria, ambient criteria, cultural factor, or content criteria parameters;
determine, as output from the algorithm, at least one particular base movie content metadata parameter and at least one particular movie content subset metadata parameter; and
identify the at least one compatible insertion location for the at least one particular base movie content or the at least one particular movie content subset by analyzing one or more of: content criteria, user criteria, cultural factors, or user device criteria parameters.

20. A non-transitory computer program product embodied on a nontransitory computer accessible storage medium comprising at least one program code instruction, said at least one program code instruction configured to enable when executed on at least one electronic computer processor to generate and transmit customized movie content to at least one end user, said nontransitory computer program product comprising the at least one program code instruction configured to enable the at least one electronic computer processor to:
electronically tag at least a portion of a plurality of movie content with at least one or more of:
stored information, or
real-time information;
first electronically determine a base movie content from the plurality of movie content,
based at least in part on at least one user criteria, and
wherein the at least one user criteria is based on at least one user information;
electronically access at least one metadata associated with the base movie content;
electronically analyze at least one capability of at least one or more of:
at least one end user device,
the at least one end user, or
at least one end user environment;
second electronically determine at least one movie content subset based on at least one or more of:
the at least one user criteria,
the at least one capability of the at least one end user device,
the at least one interest of the at least one end user,
the at least one capability of the at least one end user environment, or
the at least one metadata associated with the base movie content;
electronically select at least one selected of the at least one movie content subset, without a request for an end user acceptance confirmation, based on at least one or more of:
the at least one user criteria,
the at least one metadata associated with the base movie content,
the at least one capability of the at least one end user device,
the at least one interest of the at least one end user, or
the at least one capability of the at least one end user environment, and
wherein the electronically select at least one selected of the at least one movie content subset is obtained and analyzed, at least in part, using at least one artificial intelligence technique or machine learning technique;
electronically process the base movie content and the at least one selected of said at least one movie content subset comprising:
third electronically determine at least one insertion location associated with the base movie content for the at least one selected of said at least one movie content subset to be inserted, combined, merged or linked with the base movie content, and
wherein the electronically process of the base movie content and the at least one selected of said at least one movie content subset is derived, at least in part, using at least one artificial intelligence method or machine learning method;
electronically generate a customized movie content comprising the base movie content and the at least one selected of the at least one movie content subset for at least one end user device;
electronically evaluate at least one condition relating to at least one or more of: a network communication parameter, a network bandwidth parameter, or a network security parameter; and
electronically transmit said customized movie content to the at least one end user device.

21. The computer program product of claim 20, wherein the at least one program code instruction to first electronically determine the base movie content comprises said at least one program code instruction configured to:
electronically store the user criteria in an electronic database, wherein the at least one user criteria comprise at least one or more of: at least one user physical factor, at least one cognitive factor, at least one social factor, at least one cultural factor, at least one political factor, at least one economic factor, or at least one consumption factor;
electronically store plurality of movie content in an electronic database, wherein the plurality of movie content comprises at least one or more of: at least one text, at least one image, at least one audio, at least one language translation, at least one animation, at least one graphic, at least one three dimensional visual, or at least one video;
electronically access user selected movie content from said plurality of movie content based in part on receiving an input from the user, wherein said input comprises at least one or more of: a name of a book, a name of movie, a name of game, a name of a person, a name of music band, or a name of a virtual or augmented reality simulation;
electronically access at least one metadata associated with the user selected movie content; and
electronically analyze the at least one user criteria with the user selected movie content to fourth electronically determine the base movie content from the plurality of movie content.

22. The computer program product of claim 20, wherein the at least one program code instruction to determine the selected of at least one selected of said at least one movie content subset comprises wherein said at least one program code instruction to:
analyze the at least one metadata associated with the base movie content;
analyze at least one metadata associated with the one or more movie content subsets;
analyze the compatibility of the base movie content with the at least one movie content subset;
identify the at least one movie content subset based on a correlation between the at least one user criteria and the at least one movie content subset; and
analyze the user criteria with the at least one movie content subset to determine the one or more selected content subsets.

23. The computer program product of claim 20, wherein the at least one program code instruction to determine an insertion location comprises wherein said at least one program code instruction to:
determine one or more pre-insertion base movie content metadata;
determine one or more pre-insertion movie content subset metadata;
determine one or more user criteria, device criteria, ambient criteria, or content criteria;
evaluate one or more pre-insertion base movie content metadata, one or more pre-insertion movie content subset metadata and one or more user criteria, device criteria, ambient criteria, or content criteria before the at least one insertion location is identified;
provide, as input to an algorithm derived at least in part from a machine learning method, the one or more pre-insertion base movie content metadata, the pre-insertion movie content subset metadata, or the one or more user criteria, device criteria, ambient criteria, or content criteria;
determine, as output from the algorithm, at least one particular base movie content metadata and at least one particular movie content subset metadata; and
identify the at least one insertion location for the at least one particular base movie content or the at least one particular movie content subset taking into consideration one or more content criteria, user criteria, or device criteria.

24. The computer program product of claim 23, wherein the at least one program code instruction to derive an algorithm at least in part from a machine learning method comprises wherein said at least one program code instruction to: utilize at least one or more of linear regression, logistic regression, decision tree, random forest, dimensionality reduction, or gradient boosting.
